(19) United States
(12) Patent Application Publication
(10) Pub. No.: US 2023/0240199 A1
(43) Pub. Date: Aug. 3, 2023

(54) TIP SETTERS AND TIP ADAPTERS FOR INSTALLING INJECTION TOOLS TO PLANT PARTS

(71) Applicant: Invaio Sciences International GmbH, Basel (CH)

(72) Inventors: Urs WIDMER, Dornach (CH); Michael Christian OEHL, Reinach (CH); Lukas Rudolf SCHÜPBACH, Basel (CH); Antony Mathai CHETTOOR, Apex, NC (US); Dimitri VERWEIRE, Zurich (CH)

(73) Assignee: Invaio Sciences International GmbH, Basel (CH)

(21) Appl. No.: 18/007,673

(22) PCT Filed: Jun. 2, 2021
(86) PCT No.: PCT/EP2021/064738

§ 371 Date: Dec. 1, 2022

Related U.S. Application Data
(60) Provisional application No. 63/143,640, filed on Jan. 29, 2021.
(60) Provisional application No. 63/033,745, filed on Jun. 2, 2020.

(51) Int. Cl. A01G 7/06

(52) U.S. Cl. CPC A01G 7/06

(57) ABSTRACT

Provided herein are tip setters and tip adapters for installing injection tools to plant parts, and methods of using such tip setters and tip adapters.

### CROSS-REFERENCE TO RELATED APPLICATIONS

This application claims priority to U.S. Provisional Patent Application Nos. 63/033,745, filed Jun. 2, 2020, and 63/143,640, filed Jan. 29, 2021, each of which is incorporated herein by reference in its entirety.

### FIELD

The present disclosure relates generally to tools and methods for administering formulations to plants, and more specifically to tip setters and tip adapters for installing injection tools or injection tips to plant parts, and methods of using such tip setters and tip adapters.

### BACKGROUND

Plant injection has been used for administration of active ingredients to plants. Conventional plant injection approaches can involve drilling a borehole in a tree trunk and stoppering the borehole with a peg. A needle is inserted through the peg to discharge liquid into the borehole.

What are desired in the art are injection tools or injection tips that can be inserted directly to plant parts to supply active ingredients to the plant. What are also desired in the art are tip setters and tip adapters for installing injection tools to enable safe, efficient, and controlled installation of injection tools to plant parts.

### BRIEF SUMMARY

In some aspects, described herein are tip setters and tip adapters for installing injection tools or injection tips to plant parts, and methods of using such tip setters and tip adapters. These tip setters and tip adapters enable safe, efficient, and controlled installation of injection tools to plant parts.

In one aspect, described herein are tip setters for installing injection tools to plant parts. In some embodiments, the tip setter is a rod-type tip setter. In some variations, the tip setter is a plunger-type tip setter. In some variations, the tip setter is a lever-type tip setter. In some variations, the tip setter is a pneumatic device.

In another aspect, the tip setter for installing an injection tool to a plant part includes a rod. In some variations, the tip setter also includes a grip. In some variations, the rod has a front end and a rear end. In some variations, the front end of the rod is configured to directly or indirectly connect to, couple to, receive, or temporarily hold onto the injection tool. In some variations, the rear end of the rod is configured to convey force to the rod. In some variations, the rear end of the rod is connected to the grip.

In another aspect, described herein are methods of using the tip setter. In some embodiments, the method includes coupling the injection tool and the front end of the rod. In some variations, the method includes placing the injection tool near the plant part. In some variations, the method includes pushing the rod in the direction from the rear end of the rod to the front end of the rod to push the injection tool toward the plant part. In some variations, the method includes pushing the grip toward the plant part. In some variations, the method includes inserting at least a part of the injection tool into the plant part. In some variations, the method includes releasing the injection tool from the tip setter.

In one aspect, the tip setter for installing an injection tool to a plant part includes an arm, a fixed jaw, a middle grip, and a sliding unit. In some variations, the arm comprises: a front end and a rear end. In some variations, the fixed jaw is connected to the front end of the arm. In some variations, the middle grip is connected to the rear end of the arm. In some variations, the sliding unit comprises: a front end and a rear end. In some variations, the sliding unit is configured to slide toward the front end of the arm. In some variations, the front end of the sliding unit is configured to directly or indirectly connect to, couple to, receive, or temporarily hold onto the injection tool. In some variations, the sliding unit and the fixed jaw are configured to receive the plant part between the injection tool and the fixed jaw.

In another aspect, described herein are methods of using the tip setter. In some embodiments, the method includes coupling the injection tool and the front end of the sliding unit. In some variations, the method includes placing the plant part in between the injection tool and the fixed jaw. In some variations, the method includes pushing the sliding unit in the direction from the rear end of the arm to the front end of the arm to push the injection tool toward the plant part. In some variations, the method includes inserting at least a part of the injection tool into the plant part. In some variations, the method includes releasing the injection tool from the tip setter.

In another aspect, the tip setter for installing an injection tool to a plant part includes an arm, a handle, a locking unit, a sliding unit, and a fixed jaw. In some variations, the arm has a first actuating end and a jaw end. In some variations, the handle has a second actuating end, a pivoting end, and a sliding end. In some variations, the locking unit is connected to the pivoting end of the handle. In some variations, the sliding unit is connected to the sliding end of the handle and configured to slide along the arm between the first actuating end and the jaw end, and to directly or indirectly receive the injection tool. In some variations, the fixed jaw is connected to the jaw end of the arm. In some variations, the sliding unit and the fixed jaw are configured to receive the plant part between the injection tool and the fixed jaw.

In another aspect, described herein are methods of using the tip setter. In some embodiments, the method includes coupling the injection tool and the sliding unit. In some variations, the method includes placing the plant part in between the injection tool and the fixed jaw. In some variations, the method includes moving the first actuating end and the second actuating end toward each other to push the sliding unit and the injection tool toward the plant part. In some variations, the method includes inserting at least a part of the injection tool into the plant part. In some variations, the method includes releasing the injection tool from the tip setter.

In one aspect, described herein are tip adapters for installing injection tools to plant parts. In some embodiments, the tip adapter includes a clamp. In some variations, the tip adapter includes a connector. In some variations, the clamp has a first side, a second side, and a base that form a U-shape having an interior surface and an exterior surface. In some variations, the first side has a first lip extruding on the interior surface on the first side. In some variations, the second side has a second lip extruding on the interior surface on the second side. In some variations, the first lip and the second lip are configured to clamp on the injection tool. In some variations, the connector is connected to the exterior surface on the base.

In another aspect, described herein are methods of using the tip adapter. In some embodiments, the method includes coupling the injection tool and the tip adapter. In some variations, the method includes inserting the injection tool between the first lip and the second lip. In some variations, the method includes connecting the connector and the injection tool. In some variations, the method includes bringing the injection tool close to the plant part. In some variations, the method includes pushing the tip adapter toward the plant part to insert at least a part of the injection tool into the plant part. In some variations, pushing the tip adapter is performed by pushing the connector of the tip adapter. In some variations, the method includes releasing the injection tool from the tip adapter.

### DESCRIPTION OF THE FIGURES

The present application can be understood by reference to the following description taken in conjunction with the accompanying figures.

FIG. 1 depicts an exemplary rod-type tip setter.

FIGS. 2A and 2B depict an exemplary plunger-type tip setter.

FIGS. 3A and 3B depict an exemplary lever-type tip setter.

FIGS. 4A-4D depict an exemplary lever-type tip setter connected to a chassis housing an injection tool.

FIGS. 5A-5D depict an exemplary tip adapter.

FIGS. 6A-6D depict an exemplary tip adapter coupled to an exemplary injection tool.

FIGS. 7A-7D depict exemplary methods of using an exemplary tip adapter. FIGS. 7A and 7B depict an exemplary method for coupling an exemplary injection tool and the tip adapter.

FIGS. 7C and 7D depict an exemplary method for releasing the injection tool from the tip adapter.

FIGS. 8A-8D depict several exemplary methods and devices for pushing the tip adapter toward the plant part. FIGS. 8A and 8B show using exemplary tip setters, FIG. 8C shows using an exemplary pneumatic device with an exemplary tip setter, and FIG. 8D shows using a hammer with an exemplary tip setter.

FIGS. 9A and 9B depict exemplary injection tools that can be used with a tip setter or a tip adapter.

FIG. 10A depicts an exemplary tip adapter that can be used with an automatic hammer. FIG. 10B depicts the exemplary tip adapter of FIG. 10A and an exemplary injection tool connected to tubing. FIG. 10C depicts the exemplary tip adapter of FIGS. 10A and 10B coupled to the exemplary injection tool connected to tubing in FIG. 10B.

FIG. 11A depicts an exemplary tip adapter connected to an exemplary automatic hammer. FIGS. 11B and 11C depict tubing connected to the exemplary tip adapter of FIG. 11A, which is in turn connected to the exemplary automatic hammer.

### DETAILED DESCRIPTION

The following description sets forth exemplary methods, parameters, systems, devices and the like. It should be recognized, however, that such description is not intended as a limitation on the scope of the present disclosure but is instead provided as a description of exemplary embodiments.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The terms “comprising,” “including,” “having,” “involving” (and similarly “comprises,” “includes,” “has,” “involves,” and other forms of the terms), and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c.

Where ever the terms “a” or “an” are used, “one or more” is understood, unless such interpretation is nonsensical in context.

In some embodiments, described herein are tip setters and tip adapters for installing injection tools or injection tips to plant parts, and methods of using such tip setters and tip adapters. These tip setters and tip adapters enable safe, efficient, and controlled installation of injection tools to plant parts.

### Tip Setters

In one aspect, described herein are tip setters for installing injection tools to plant parts. In some embodiments, the tip setter is a rod-type tip setter. In some variations, the tip setter is a plunger-type tip setter. In some variations, the tip setter is a lever-type tip setter. In some variations, the tip setter is a pneumatic device. In some variations, the tip setter is an electronic device.

### Rod-Type Tip Setters

In some embodiments, the tip setter for installing an injection tool to a plant part includes a rod. In some variations, the tip setter also includes a grip. In some variations, the rod has a front end and a rear end. In some variations, the front end of the rod is configured to directly or indirectly connect to, couple to, receive, or temporarily hold onto the injection tool. In some variations, the rear end of the rod is configured to convey force to the rod. In some variations, the rear end of the rod is connected to the grip.

In some embodiments, the front end of the rod is configured to directly receive the injection tool. In some variations, the front end of the rod is configured to indirectly receive the injection tool. In some variations, the front end of the rod is configured to receive a chassis housing the injection tool. In some variations, the front end of the rod is configured to receive a tip adapter coupled to the injection tool.

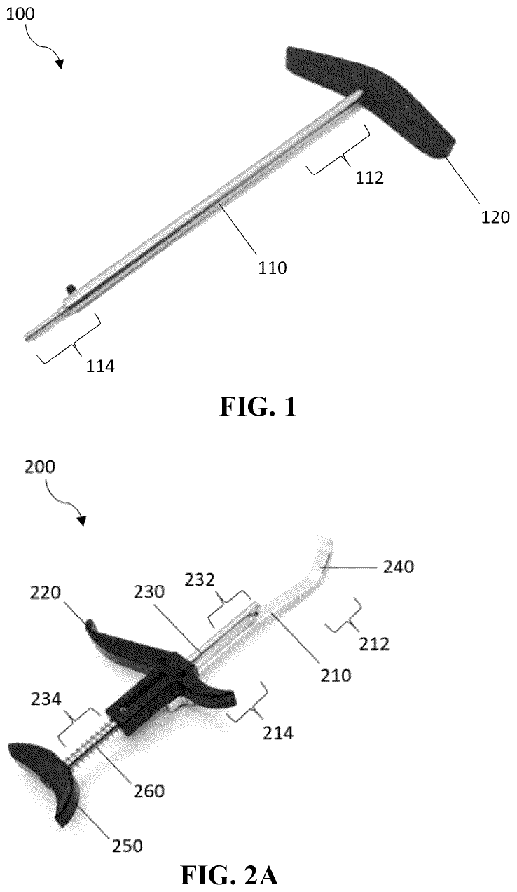

FIG. 1 depicts an example of a rod-type tip setter (tip setter 100). Tip setter includes rod 110 and grip 120. Rod 110 has grip end 112 and receiving end 114.

In another aspect, described herein are methods of using the tip setter. In some embodiments, the method includes coupling the injection tool and the front end of the rod. In some variations, the method includes placing the injection tool near the plant part. In some variations, the method includes pushing the rod in the direction from the rear end of the rod to the front end of the rod to push the injection tool toward the plant part. In some variations, the method includes pushing the grip toward the plant part. In some variations, the method includes inserting at least a part of the injection tool into the plant part. In some variations, the method includes releasing the injection tool from the tip setter.

In some embodiments, this tip setter can be used to install injection tools for small diameter and soft tissue trees/plants. For example, in certain embodiments, the plant has a trunk or stem diameter between 1 mm and 40 mm. In other embodiments, the tip setter can be used for installing an injection tool to a plant part whose trunk diameter is: more than 1 mm; more than 2 mm; more than 4 mm; more than 6 mm; more than or equal to 8 mm; more than or equal to 10 mm; more than or equal to 15 mm; more than or equal to 20 mm; or more than or equal to 40 mm.

In some embodiments, parts of the tip setter can be made of plastic such as polyoxymethylene (POM) or metal such as stainless steel or aluminum. In some variations, the rod is made of metal such as stainless steel. In some variations, the grip is made of plastic such as POM.

### Plunger-Type Tip Setters

In some embodiments, the tip setter for installing an injection tool to a plant part includes an arm, a fixed jaw, a middle grip, and a sliding unit. In some variations, the arm comprises: a front end and a rear end. In some variations, the fixed jaw is connected to the front end of the arm. In some variations, the middle grip is connected to the rear end of the arm. In some variations, the sliding unit comprises: a front end and a rear end. In some variations, the sliding unit is configured to slide toward the front end of the arm. In some variations, the front end of the sliding unit is configured to directly or indirectly connect to, couple to, receive, or temporarily hold onto the injection tool. In some variations, the sliding unit and the fixed jaw are configured to receive the plant part between the injection tool and the fixed jaw.

In some embodiments, the front end of the sliding unit is configured to directly receive the injection tool. In some variations, the front end of the sliding unit is configured to indirectly receive the injection tool. In some variations, the front end of the sliding unit is configured to receive a chassis housing the injection tool. In some variations, the front end of the sliding unit is configured to receive a tip adapter coupled to the injection tool.

In some embodiments, the tip setter includes a rear grip. In some variations, the rear grip is connected to the rear end of the sliding unit. In some variations, the rear grip is configured to convey force to the sliding unit.

In some embodiments, the tip setter includes a biasing element. In some variations, the biasing element is in between the middle grip and the rear grip. In some variations, the biasing element is configured to create resistance in moving the sliding element toward the front end of the arm. In some variations, the biasing element is a spring. In some variations, the biasing element is configured to allow for better control in installing the injection tool into the plant part. In some variations, the biasing element allows for the tip setter to be used for installing an injection tool to a plant part with greater hardness. In some variations, the by controlling or increasing the strength of the biasing element, plunger-type tip setters can be used for installing an injection tool to a plant part with greater hardness.

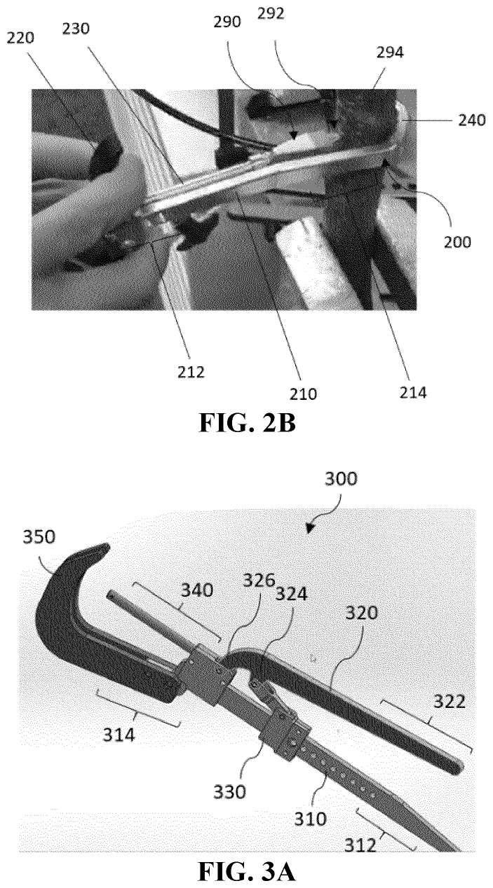

FIGS. 2A and 2B depict an example of a plunger-type tip setter (tip setter 200). Tip setter 200 includes arm 210, middle grip 220, sliding unit 230, fixed jaw 240, rear grip 250, and biasing element 260. Arm 210 has front end 212 and rear end 214. Sliding unit 230 has front end 232 and rear end 234. Also depicted in FIG. 2B are an exemplary tip adapter (tip adapter 290), an exemplary injection tool (injection tool 292), and plant part 294.

In another aspect, described herein are methods of using the tip setter. In some embodiments, the method includes coupling the injection tool and the front end of the sliding unit. In some variations, the method includes placing the plant part in between the injection tool and the fixed jaw. In some variations, the method includes pushing the sliding unit in the direction from the rear end of the arm to the front end of the arm to push the injection tool toward the plant part. In some variations, the method includes inserting at least a part of the injection tool into the plant part. In some variations, the method includes releasing the injection tool from the tip setter.

In some embodiments, the tip setter can be used for installing an injection tool to a plant part whose trunk diameter is: between 1 mm and 100 mm; between 2 mm and 100 mm; between 4 mm and 100 mm; between 8 mm and 100 mm; between 8 mm and 80 mm; between 8 mm and 60 mm; between 8 mm and 40 mm; between 8 mm and 20 mm; between 10 mm and 20 mm; between 10 mm and 40 mm; between 10 mm and 60 mm; between 10 mm and 80 mm; or between 10 mm and 100 mm.

In some embodiments, parts of the tip setter can be made of plastic such as polyoxymethylene (POM) or metal such as stainless steel or aluminum. In some variations, the arm is made of metal such as stainless steel or aluminum. In some variations, the fixed jaw is made of plastic such as POM or metal such as stainless steel or aluminum. In some variations, the middle grip is made of plastic such as POM. In some variations, the sliding unit is made of metal such as stainless steel or aluminum. In some variations, the rear grip is made of plastic such as POM.

### Lever-Type Tip Setters

In some embodiments, the tip setter for installing an injection tool to a plant part includes an arm, a handle, a locking unit, a sliding unit, and a fixed jaw. In some variations, the arm has a first actuating end and a jaw end. In some variations, the handle has a second actuating end, a pivoting end, and a sliding end. In some variations, the locking unit is connected to the pivoting end of the handle. In some variations, the sliding unit is connected to the sliding end of the handle and configured to slide along the arm between the first actuating end and the jaw end, and to directly or indirectly receive the injection tool. In some variations, the fixed jaw is connected to the jaw end of the arm. In some variations, the sliding unit and the fixed jaw are configured to receive the plant part between the injection tool and the fixed jaw.

In some embodiments, the locking unit can be in an adjustable mode or a fixed mode. In some variations, when the locking unit is in the adjustable mode, the locking unit can change position on the arm between the first actuating end and the jaw end. In some variations, when the locking unit is in the fixed mode, the locking unit is fixed at a position on the arm between the first actuating end and the jaw end.

In some embodiments, when the first actuating end and the second actuating end are moved toward each other while the locking unit is locked at a position on the arm, the sliding unit is configured to slide along the arm toward the jaw end of the arm, thereby moving the injection tool toward the plant part with sufficient force to penetrate the plant part.

In some embodiments, the sliding unit is configured to directly receive the injection tool. In some variations, the sliding unit is configured to indirectly receive the injection tool. In some variations, when the sliding unit is configured to indirectly receive the injection tool, the sliding unit is configured to receive a chassis housing the injection tool. In some variations, when the sliding unit is configured to indirectly receive the injection tool, the sliding unit is configured to receive a tip adapter coupled to the injection tool.

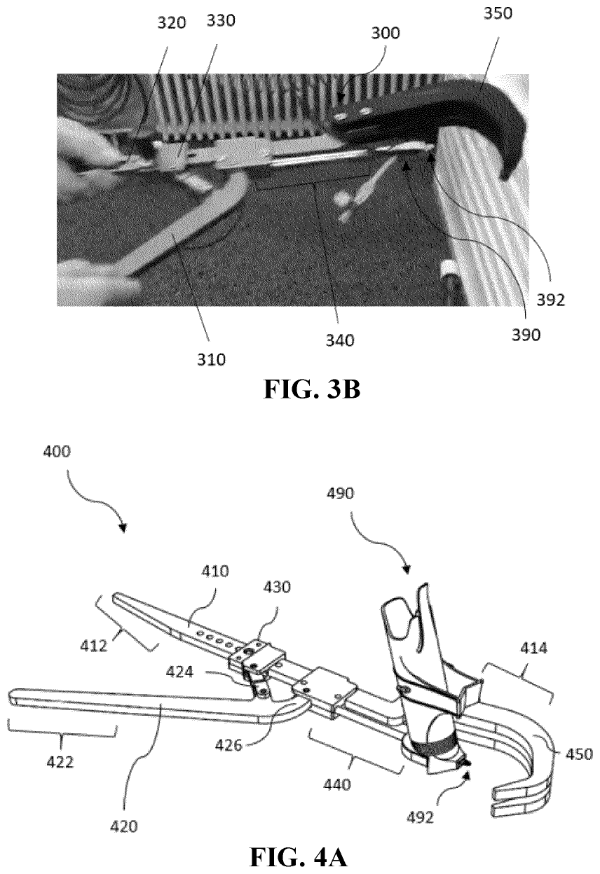

FIGS. 3A and 3B depict an example of a lever-type tip setter (tip setter 300), which includes arm 310, handle 320, locking unit 330, sliding unit 340, and fixed jaw 350. Arm 310 has first actuating end 312 and jaw end 314. Handle 320 has second actuating end 322, pivoting end 324, and sliding end 326. Also depicted in FIG. 3B are tip adapter 390 coupled to injection tool 392.

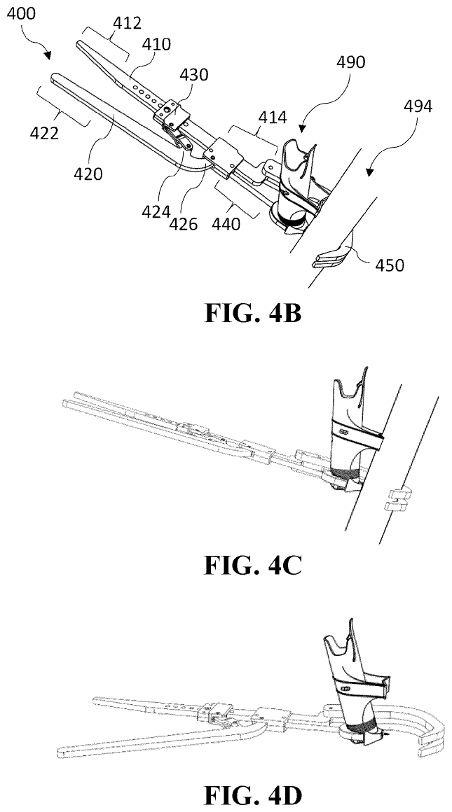

FIGS. 4A and 4B depict an example of a lever-type tip setter (tip setter 400), which includes arm 410, handle 420, locking unit 430, sliding unit 440, and fixed jaw 450. Arm 410 has first actuating end 412 and jaw end 414. Handle 420 has second actuating end 422, pivoting end 424, and sliding end 426. The figures also depict chassis 490 housing injection tool 492 (injection tool is inserted in plant part 494 in FIG. 4B and not shown in FIG. 4B).

In another aspect, described herein are methods of using the tip setter. In some embodiments, the method includes coupling the injection tool and the sliding unit. In some variations, the method includes placing the plant part in between the injection tool and the fixed jaw. In some variations, the method includes moving the first actuating end and the second actuating end toward each other to push the sliding unit and the injection tool toward the plant part. In some variations, the method includes inserting at least a part of the injection tool into the plant part. In some variations, the method includes releasing the injection tool from the tip setter.

In some embodiments, the tip setter can be used for installing an injection tool to a plant part whose trunk diameter is: more than 1 mm; more than 5 mm; more than 10 mm; more than 15 mm; more than 20 mm; more than 40 mm; more than 60 mm; more than 80 mm; more than 100 mm; more than 120 mm; more than 150 mm; between 1 mm and 10 mm; between 10 mm and 100 mm; between 15 mm and 100 mm; between 15 mm and 120 mm; between 15 mm and 150 mm; between 50 mm and 200 mm; or between 50 mm and 300 mm.

In some embodiments, certain tip setters as described herein, such as the exemplary tip setters in FIGS. 3A, 3B, and 4A-4D, may be used for installing an injection tool to a trunk of a juvenile tree. In some embodiments, certain the tip setters as described herein, such as the exemplary tip setters in FIGS. 3A, 3B, and 4A-4D, may be used for installing an injection tool to a citrus tree. In some embodiments, certain tip setters as described herein, such as the exemplary tip setters in FIGS. 3A, 3B, and 4A-4D may be used for installing an injection tool to a lemon tree, orange tree, lime tree, kumquat tree, grapefruit tree, tangerine tree, clementine tree, or mandarin tree.

In some embodiments, parts of the tip setter can be made of plastic such as polyoxymethylene (POM) or metal such as stainless steel or aluminum. In some variations, the arm is made of plastic such as POM or metal such as stainless steel or aluminum. In some variations, the handle is made of plastic such as POM or metal such as stainless steel or aluminum. In some variations, the fixed hook made of plastic such as POM or metal such as stainless steel or aluminum. In some variations, the sliding unit is made of plastic such as POM or metal such as stainless steel or aluminum. In some variations, the locking unit is made of plastic such as POM or metal such as stainless steel or aluminum.

### Automatic Hammer Tip Setters

In some embodiments, the tip setter comprises: an automatic hammer; and a tip adapter, wherein the automatic hammer is configured to receive the tip adapter. In certain embodiments, the tip adapter comprises: a clamp and a connector. In some variations, the clamp has a first side, a second side, and a base that form a U-shape or a U-shape cavity having an interior surface and an exterior surface. In some variations, the first side has a first structural element on the interior surface on the first side; the second side has a second structural element on the interior surface on the second side; and the first structural element and the second structural element are configured to receive the injection tool with a complementary structure. In some variations, the first side has a first lip extruding on the interior surface on the first side; the second side has a second lip extruding on the interior surface on the second side; and the first lip and the second lip are configured to clamp on an injection tool. In some variations, the connector is connected to the exterior surface on the base, and the connector is configured to insert into or couple with the automatic hammer. Any suitable injection tools, including the ones described herein, may be used with the tip adapter.

In some embodiments, the tip setter comprises the injection tool interfaced with the tip adapter. In some variations, the injection tool is releasably interfaced with the tip adapter. In some variations, the injection tool comprises a tool body comprising a portion designed to be lodged into the plant part and at least one port connectable to tubing, wherein the portion designed to be lodged into the plant part is positioned externally to the tip adapter and the at least one port is positioned internally in the tip adapter. In some variations, the at least a portion of the tubing is positioned within the tip adapter.

In some embodiments, the injection tool comprises a tool body having a portion designed to be lodged into the plant part and a tool base connected to the tool body. In some variations, the tool base comprises at least one port configured to receive active ingredient. In some variations, the tool body comprises a channel system connected to at least one port, and the channel system is configured to distribute the active ingredient through the tool body into the plant part. In some variations, the tool base comprises at least one structural element configured to interface with the tip adapter. In some variations, one or both sides of the tool base comprise a groove designed to engage with the first lip and/or the second lip of the tip adapter, so as to secure the injection tool within the tip adapter.

In some embodiments, the injection tool is coupled to the tip adapter. In some variations, the injection tool can be released from the tip adapter. In some variations, the injection tool comprises a tool body comprising a portion designed to be lodged into the plant part and at least one port connectable to tubing, wherein the portion designed to be lodged into the plant part is positioned outside the tip adapter or the U-shape cavity of the tip adapter and the at least one port is positioned inside the tip adapter or the U-shaped cavity of the tip adapter. In some variations, the injection tool is connected to tubing, wherein at least a portion of the tubing is positioned inside the tip adapter or the U-shape cavity of the tip adapter.

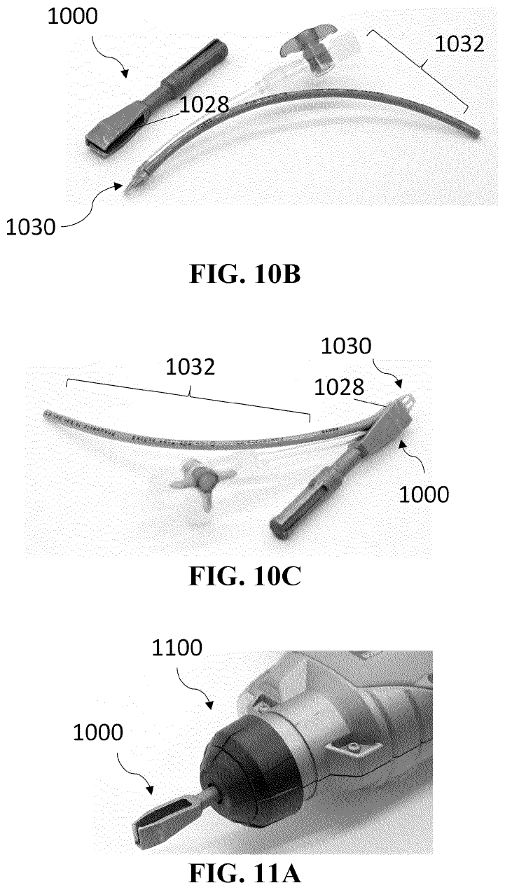

FIG. 10A depicts exemplary tip adapter 1000 configured for use with an automatic hammer. As depicted, tip adapter 1000 comprises clamp 1020 that forms a U-with open side 1028. Clamp 1002 has first side 1022, second side 1024 and base 1026. Connector 1010 is connected to base 1026, and is configured to insert into or couple with an automatic hammer as described herein. FIG. 10B depicts exemplary injection tool 1030 with two ports that are connected to tubing 1032, along with tip adapter 1000. FIG. 10C depicts injection tool 1030 connected to tubing 1032 positioned in tip adapter 1000. Open side 1028 of tip adapter 1000 allows insertion of an injection tool with tubing already connected. Such tubing may further connect with, for example, a fluid delivery system containing the active ingredient(s).

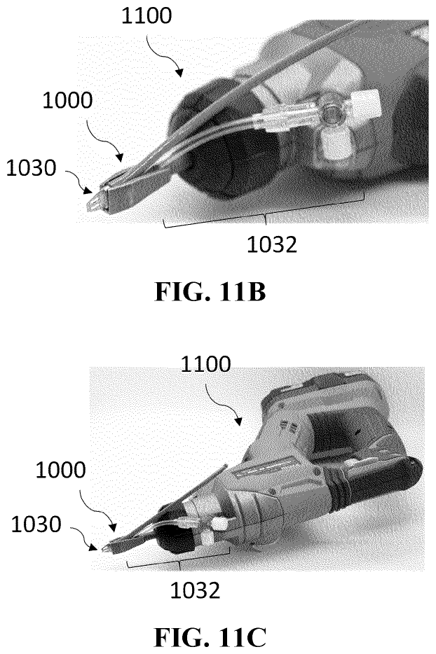

FIG. 11A depicts tip adapter 1000 connected to (or inserted into) exemplary automatic hammer 1100. FIGS. 11B and 11C depict injection tool 1030 connected to tubing 1032 inserted into tip adapter 1000, and tip adapter 1000 is connected to (or inserted into) automatic hammer 1100.

Various types of automatic hammers may be used. For example, in some variations, suitable automatic hammers include devices with a hammer function (also known in the art as a chisel function). In some variations, the automatic hammer is a hammer drill or impact driver that has a hammer-only function, e.g. wherein the hammer drill has a non-rotation setting for creating stroke force but no rotation.

In some variations, the automatic hammer is a rotary drill or wrench with an impact mechanism that generates an impact or hammering motion. In some variations, the automatic hammer is a hammer drill, percussion drill, or impact drill. In some variations, the automatic hammer is an air drill. In certain variations, the automatic hammer is an impact driver. In certain variations, the automatic drill is an impact wrench, impactor, impact gun, air wrench, air gun, rattle gun, torque gun, or windy gun. In certain variations of the foregoing, the automatic hammer has a hammer function or a hammer-only function.

In some embodiments, the automatic hammer operates with electricity as the power source. In some embodiments, the automatic hammer is an electric device. In some embodiments, the automatic hammer operates with compressed air as the power source. In some embodiments, the automatic hammer is a pneumatic device. In some embodiments, the automatic hammer operates with electricity and compressed air. The automatic hammer may be corded or cordless.

In some embodiments, the automatic hammer is configured to exert a stroke force without rotation on the tip adapter connected to the injection tool, so as to insert at least a part of the injection tool into a plant part.

In another aspect, described herein is a method of using the automatic hammer tip setters described herein. In some embodiments, the method comprises coupling the injection tool and the tip adapter; placing the injection tool near the plant part; operating the automatic hammer to push the injection tool toward the plant part; and inserting at least a part of the injection tool into the plant part. In some variations, the method further comprises releasing the injection tool from the tip setter.

In some embodiments, the automatic hammer tip setter is used for installing an injection tool to a tree trunk with a diameter of more than 1 inch, more than 2 inches, more than 3 inches, more than 4 inches, more than 5 inches, more than 6 inches, more than 7 inches, more than 8 inches, more than 9 inches, more than 10 inches, more than 15 inches, or more than 20 inches. In some variations, the automatic hammer tip setter is used for installing an injection tool to the trunk of mature trees. In other variations, the automatic hammer tip setter is used for installing an injection tool to the trunk of an olive tree.

### Tip Adapters

In one aspect, described herein are tip adapters for installing injection tools to plant parts. In some embodiments, the tip adapter includes a clamp, and a connector. In some variations, the clamp has a first side, a second side, and a base that form a U-shape having an interior surface and an exterior surface. In some variations, the first side has a first structural element in the interior surface on the first side; the second side has a second structural element in the interior surface on the second side; and the first structural element and the second structural element are configured to receive the injection tool with a complementary structure. In some variations, the first side has a first lip extruding on the interior surface on the first side; the second side has a second lip extruding on the interior surface on the second side; and the first lip and the second lip are configured to clamp on the injection tool. In some variations, the first side has a first groove in the interior surface on the first side; the second side has a second groove in the interior surface on the second side; and the first groove and the second groove are configured to receive the injection tool with a complementary structure. In some variations, the first side has a first lip extruding on the interior surface on the first side; the second side has a second groove in the interior surface on the second side; and the first lip and the second groove are configured to receive the injection tool with a complementary structure. In some variations, the connector is connected to the exterior surface on the base.

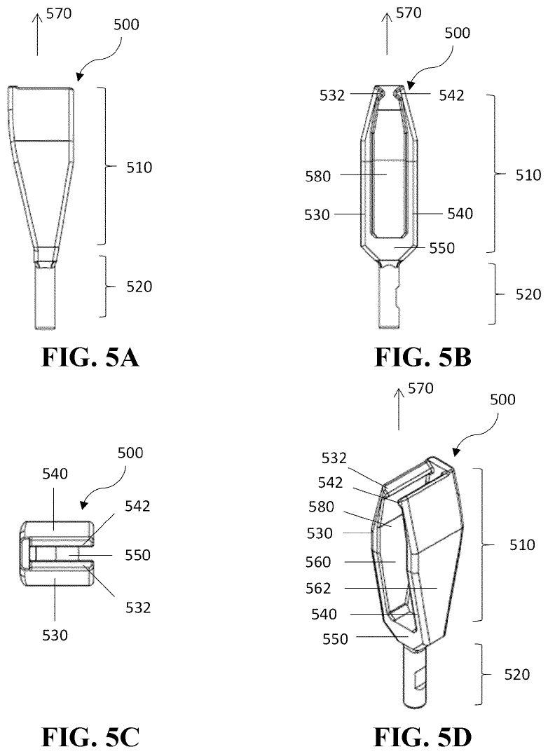

As described above, and as depicted in FIGS. 5B and 5D, the clamp forms a U-shape with open side 580. This allows insertion of an injection tool through open side 580 into the clamp of the tip adapter while tubing is already connected to the one or more ports of the injection tool.

In some embodiments, the tip adapter includes a connector. In some variations, the connector has a front end and a rear end. In some variations, the front end of the connector is configured to directly receive the injection tool. In some variations, the front end of the connector is configured to indirectly receive the injection tool. In some variations, the front end of the connector is configured to receive the clamp coupled to the injection tool. In some variations, the rear end of the connector is configured to connect to a tip adapter. In some variations, the rear end of the connector is configured to connect to the front end of the rod of rod-type tip setter. In some variations, the rear end of the connector is configured to connect to the front end of the sliding unit of a plunger-type tip setter. In some variations, the rear end of the connector is configured to connect to the sliding unit of a lever-type tip setter. In some embodiments, the rear end of the connector is configured to connect to an automatic hammer tip setter.

FIGS. 5A-5D depict an example of a tip adapter (tip adapter 500), which includes clamp 510 and connector 520. Clamp 510 has first side 530, second side 540, and base 550, that form a U-shape having interior surface 560 and exterior surface 562. First side 530 has first lip 532, and second side 540 has second lip 542, both on interior surface 560. Connector 520 is connected to exterior surface 562 on base 550. Arrow 570 indicates the longitudinal axis of tip adapter 500. Open side 580 is on one side of the clamp.

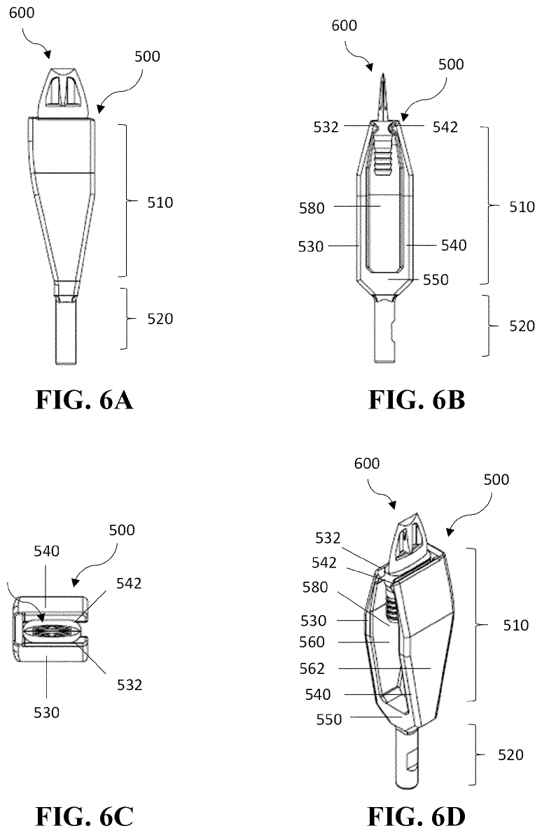

FIG. 6 depicts an exemplary injection tool (injection tool 600) inserted into the tip adapter of FIG. 5 (tip adapter 500).

In another aspect, described herein are methods of using the tip adapter. In some embodiments, the method includes coupling the injection tool and the tip adapter. In some variations, the method includes inserting the injection tool between the first structural element and the second structural element of the tip adapter. In some variations, the method includes inserting the injection tool between the first lip and the second lip. In some variations, the method includes connecting the connector and the injection tool. In some variations, the method includes bringing the injection tool close to the plant part. In some variations, the method includes pushing the tip adapter toward the plant part to insert at least a part of the injection tool into the plant part. In some variations, pushing the tip adapter is performed by pushing the connector of the tip adapter. In some variations, the method includes releasing the injection tool from the tip adapter.

In some embodiments, pushing the tip adapter toward the plant part is in the same direction as the longitudinal axis of the tip adapter. In some variations, pushing the tip adapter toward the plant part is performed manually. In some variations, pushing the tip adapter toward the plant part is performed using a hammer. In some variations, pushing the tip adapter toward the plant part is performed using a pneumatic device. In some variations, pushing the tip adapter toward the plant part is performed using a tip setter. In some variations, pushing the tip adapter toward the plant part is performed using a tip setter described herein.

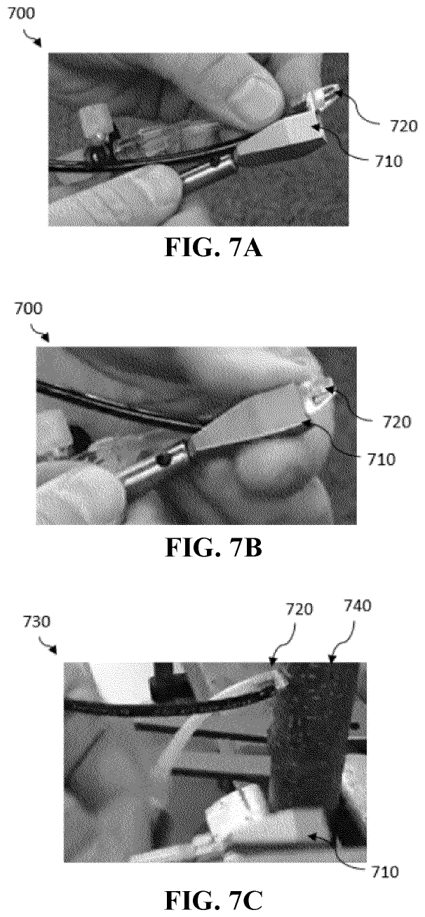

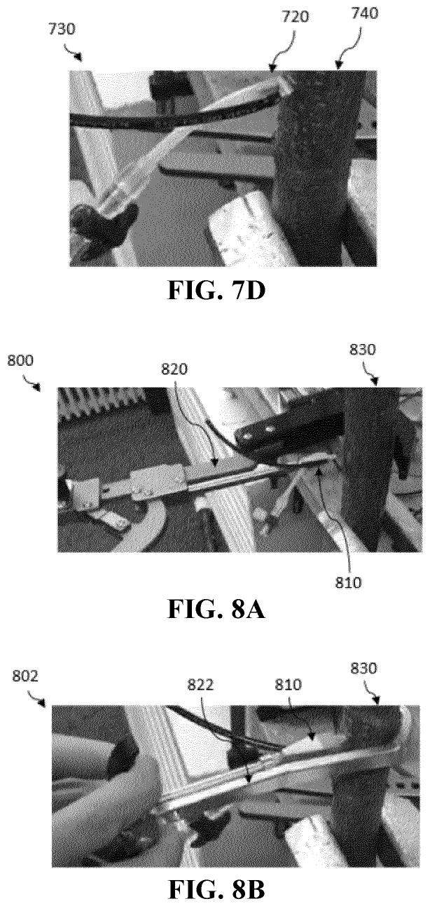

FIGS. 7A-7D depict exemplary methods 700 and 730 of using an exemplary tip adapter (tip adapter 710) with an exemplary injection tool (injection tool 720). FIGS. 7A and 7B depict method 700 for coupling tip adapter 710 and injection tool 720, by inserting injection tool 720 between the first lip and the second lip of tip adapter 710. FIG. 7A depicts right before inserting injection tool 720 into tip adapter 710, and FIG. 7B depicts right after the insertion. FIGS. 7C and 7D depict method 730 for releasing tip adapter 710 from injection tool 720 that is inserted in plant part 740. FIG. 7C shows sliding tip adapter 710 sideways to release injection tool 720, and FIG. 7D shows injection tool 720 after being released from tip adapter 710.

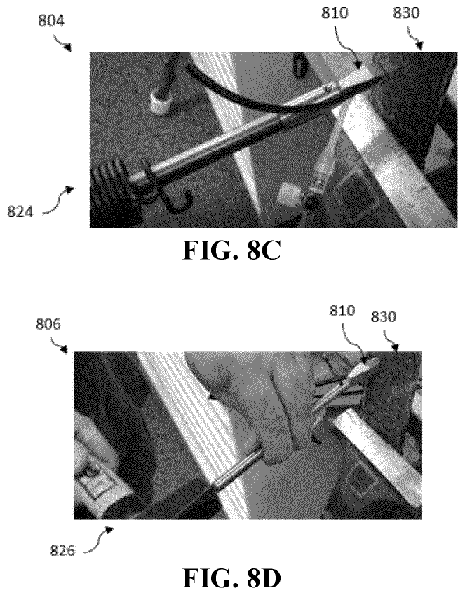

FIGS. 8A-8D depict exemplary methods 800, 802, 804, and 806 of pushing an exemplary tip adapter (tip adapter 810) toward plant part 830. FIG. 8A depicts method 800 where an exemplary tip setter (tip setter 820) is used to push tip adapter 810 toward plant part 830. FIG. 8B depicts method 802 where an exemplary tip setter (tip setter 822) is used to push tip adapter 810 toward plant part 830. FIG. 8C depicts method 804 where an exemplary pneumatic device (pneumatic device 824) is used to push tip adapter 810 toward plant part 830. FIG. 8D depicts method 806 where an exemplary hammer (hammer 826) is used to push tip adapter 810 toward plant part 830.

In some embodiments, the tip adapter can be used for installing an injection tool to a plant part whose trunk diameter is: more than or equal to 1 mm; more than or equal to 5 mm; more than or equal to 10 mm; more than or equal to 15 mm; more than or equal to 20 mm; more than or equal to 40 mm; more than or equal to 60 mm; more than or equal to 80 mm; more than or equal to 100 mm; more than or equal to 120 mm; more than or equal to 150 mm; more than or equal to 300 mm; or more than or equal to 500 mm.

In some embodiments, parts of the tip adapter can be made of metal such as cobalt chrome. In some variations, the connector is made of metal such as cobalt chrome. In some variations, the clamp is made of metal such as cobalt chrome. In some variations, the parts of the tip adapter is 3D printed. In some variations, the clamp is 3D printed. In some variations, the connector is 3D printed.

### Injection Systems

Any injection systems compatible with the tip adapters and tip setters described herein may be used. Suitable injection systems are described in, e.g., WO 2020/021041. In some embodiments, the injection system are for administering fluids, for example, liquid formulations including one or more active ingredients (AIs), directly into the interior of a plant part. In some variations, the injection systems include an injection tool. In some variations, the injection systems include a fluid delivery system. In some variations, the fluid delivery system include a source of liquid supply. In some variations, the injection systems include a fluid receiving device. In some variations, the injection systems include a chassis.

In some aspects, provided herein are plant injection systems compatible with the tip adapters and tip setters described herein, for administering fluids, for example, liquid formulations including one or more active ingredients, to a plant comprising a multiport injection tool. In some embodiments, the plant injection systems comprise a fluid delivery system, a fluid receiving system, and a multiport injection tool, wherein the fluid delivery system is operatively connected to a first port of the multiport injection tool and the fluid receiving system is in fluid communication with a second port of the multiport injection tool. In some variations, the fluid delivery system facilitates flow of fluid from a source of fluid supply through a channel system in the multiport injection tip from a first access port to a second access port and to distribution port(s) and consequently to the interior of the plant. In some variations, the fluid receiving system may have an open position in which fluid may flow through or be evacuated from the fluid receiving system and a closed position in which fluid is retained in the fluid receiving system.

### Chassis

Any chassis compatible with the tip adapters and tip setters described herein may be used. Suitable chassis are described in, e.g., WO 2020/021041. For example, in some embodiments, the chassis is for integrating components of injection systems such as injection tools. For example, one such housing may be configured to receive a pressurized canister (the fluid delivery system), which delivers AI fluid when activated, while also integrating the injection tool and componentry for operatively connecting the injection tool to the pressurized canister. In another example, the housing is configured: to integrate the injection tool and componentry for fluidly connecting the injection tool to the fluid delivery system; and, to install the injection tool and maintain it in position in the trunk of a plant. In some such embodiments, the housing is a composite chassis.

In some embodiments, the chassis includes a delivery interface extending between the cartridge magazine and the injection tool. The delivery interface fluidly interconnects the cartridge magazine with the one or more distribution ports of the injection tool.

In some embodiments, the chassis stores active ingredient (AI) formulations and delivers the formulations to an injection tool provided on board with the remainder of the system. In some variations, the chassis is installed as a consolidated assembly proximate to the plant (e.g., coupled along a stem, trunk or the like) with the injection tool penetrated into the plant active vascular tissue. In other examples, the chassis is also installed as a consolidated assembly but at an angle to the post portion of the plant. In some variations, the chassis is optionally additionally coupled to the plant, for instance, with one or more installation brackets, straps, belts, fasteners or the like. In some variations, the chassis includes a support framework that retains each of the components, such as a formulation reservoir for the formulation, the injection tool, and interconnecting fluid interfaces within the framework to facilitate installation of the system to the plant.

In some embodiments, the chassis is pushed into a post portion of a plant to install the injection tool into the plant. In some embodiments, a tip setter may be used to help with installation of the chassis and injection tool onto and into the plant. For example, the tip setter may be a lever-type device including expandable jaws which can receive the chassis and post portion of the plant. The jaws may then be brought closer together in order to bring the chassis closer to the plant and push the installation tool into the plant. In some embodiments, the bottom portion of the chassis which receives the tip has an arrow-like shape, the grooves of which are designed to engage with a tip setter. In some embodiments, at least a portion of the fluid receiving system includes a flexible portion, for example, to mitigate damage to the tip during installation. In some variations, the chassis can be optionally further coupled to the post portion of the plant, for example, to provide additional stability and/or help maintain the installed injection tool in place. In some variations, the AI formulation cartridge is placed in the cartridge magazine, and in some embodiments, installation of a formulation cartridge automatically activates the cartridge, opening the formulation cartridge and initiating fluid communication between the formulation to the injection tool. In other embodiments, the cartridge can be stored in the magazine and activated at a desired time, for example, by pressing down on the cartridge such as by screwing down a cap onto the magazine. In other embodiments, a flange may engage the cartridge resulting in activating the cartridge and maintaining it in place. In some embodiments, the position of the flange is adjustable to accommodate different length canisters and/or to permit activation at a desired time. Thus, in some embodiments, the plant injection system is thereby operated with minimal exposure of the formulation to an exterior environment. Instead, the AI formulation is administered in an enclosed (e.g., sealed) manner from the formulation cartridge to the injection tool within the plant. Accordingly, even formulations that are not indicated for exterior use or exposure may be usable with the plant injection system.

The plant injection system is, in one example, serviced by removing an empty formulation cartridge and coupling a replacement cartridge within the cartridge magazine. The exchange of cartridges is straightforward and rapid and can therefore provide substantially uninterrupted administration of AI fluid to the plant. Optionally, the plant injection system includes a delivery interface having a body access port, such as a fill port that provides additional capabilities to the system. The body access port optionally allows for in service refilling of a formulation cartridge by administration of replacement formulation through the body access port that is delivered to the formulation cartridge. In other examples, the body access port facilitates the bleeding or initialization of the system. The formulation from the formulation cartridge is delivered under pressure through the injection tool and to the body access port. Intervening fluids, such as in line air, residual formulations or the like are bled from the access port, for instance, into a catching reservoir. Accordingly, in some embodiments, even refilling, replacement and initialization of the system are optionally conducted with minimal exposure to an exterior environment.

Injection tools

Any injection tools compatible with the tip adapters and tip setters described herein may be used. Suitable injection tools are described in, e.g., WO 2020/021041. For example, in some embodiments, the injection tools include a tool body, at least a portion of which is designed to be lodged into a plant, for example, the stem or trunk of a plant. The tool body has a channel system (having one or more channels) through which fluid can flow, terminating in an entry port through which fluid enters the injection tool and one or more distribution ports through which fluid is delivered to the interior of the plant. In some embodiments, the channel system provides fluid communication between the distribution ports and access ports. A person of skill, based upon this disclosure can envision a variety of injection tools that may be modified as multiport injection tools consistent with this disclosure. For example, in some variations, other injection tools described herein can be modified to include two access ports in fluid communication with a channel system providing fluid communication between the access ports and distribution ports.

In some embodiments, the multiport injection tool compatible with the tip adapters and tip setters described herein has an insertion end which is inserted into a plant and an exposed end which remains outside of the plant to facilitate coupling and decoupling of the multiport injection tool to the fluid delivery system and/or the fluid receiving system. In some embodiments, multiport injection tip is sized and shaped to minimize damage to the target plant when inserted into the plant, while maintaining efficient functionality of the tip in delivering the desired dosing of AI fluid over the desired time period directly to the sapwood and not the heartwood of the trunk.

In some embodiments, the injection tool is a multiport injection tool including a first access port, a second access port, the one or more distribution ports, and the channel system, which establishes fluid communication between the first and second access ports and the one or more distribution ports. In some variations, when the multiport injection tool is used in a plant injection system having a fluid receiving device, the multiport injection tool is positioned in the trunk of a plant in fluid communication with the fluid delivery system, and the fluid delivery system is activated, fluid flows from the fluid delivery device through the multiport injection tool from the first access port to the distribution ports for delivery into the trunk of a plant and to the second access port.

Without being bound by theory, it is believed that because the one or more distribution ports administer liquid formulations along a different vector relative to the longitudinal body axis of the penetrating distribution body, the ports remain open (e.g., clear of plant tissue) and minimal pressure (relative to pressure applied with a driven plunger and cylinder) administers the liquid formulation. For example, the one or more distribution ports open, extend laterally, distribute the liquid formulation or the like in a misaligned orientation (e.g., transverse, along an offset angle, orthogonal, greater than 5 degrees, greater than 10 degrees or more) relative to the longitudinal body axis to thereby minimize clogging from plant tissue.

In other examples, the one or more distribution ports are recessed from an exterior of a body profile of the penetrating distribution body, and accordingly remain clear of plant tissue. For example, the one or more distribution ports are provided along the troughs of anchor elements (e.g., threading, flutes, serrations, cleats, scalloped surfaces or the like), within distribution reservoirs within the body profile of the penetrating distribution body or the like. In some embodiments, the one or more distribution ports are within the body profile and with penetration of the plant tissue the ports are not engaged with plant tissue in a manner that promotes clogging. Instead, the one or more distribution ports are recessed from the penetrating element and, at least in some examples, the plant tissue itself. Accordingly, liquid formulations delivered to the injection tool are readily received in the plant and delivered with minimal pressure or effort. Further, in examples including cavities, the proximate walls, surfaces or the like of the injection tool in combination with the surrounding plant tissue provide reservoirs within the plant, and the liquid formulations reside in these reservoirs for gradual uptake by the plant.

In some embodiments, the injection tools described herein are installed in plants having relatively small and large sizes or diameters (e.g., trunk or stem diameters). In one example, the portions of the injection tools installed in plants have dimensions of around 5 mm or less (e.g., width) and 1 mm or less (e.g., height) and accordingly the tools are configured for installation in plants with stems, trunks, roots, limbs or the like of 5 mm or more in size, such as diameter.

In some variations, any injection tool compatible with the tip adapters and tip setters described herein may be used further with a formulation cartridge. In some embodiments, the injection tool can be set or advanced into the plant independent of the formulation cartridge and thus the active ingredient formulation. This allows for providing a safe process not risking any leakage or other disposal of the active ingredient formulation out of the system. Further, the plant injection system allows for a convenient long term treatment of the plant by a comparably low skilled user, which may result in an efficient and accurate delivery of the liquid active ingredient formulation into the plant.

In some embodiments, for example, when the injection tool is inserted for long-term use, the injection tool is configured to be secured into the plant such that the insert portion is not readily linearly extractable out of the plant.

In some embodiments, the lodged portion of the tool is sized and shaped to minimize damage to the target plant when inserted into the plant, while maintaining efficient functionality of the injection tool in delivering the desired dosing of liquid formulation over the desired time period directly to the active vasculature of the plant. In some variations, penetrating element and tool base are cooperatively sized and shaped to work together to minimize damage to the target plant while maintaining efficient functionality of the tip. For example, the length of penetrating element may be chosen to be less than the depth of the sapwood in the trunk of the tree and tool base is configured with a flange abutting the bottom end of penetrating element. In some variations, the flange is sized and shaped to mitigate the risk of inserting the injection tool beyond the end of penetrating element abutting flange and therefore beyond the inner circumference of the sapwood and into the heartwood. In some variations, flange has a width that is wider than the widest part of penetrating element. In one example, the multiport injection tip includes one or more dimensions configured to minimize trauma to the plant caused during installation. The minimal profile of the tip (as well as other tip embodiments described herein) minimizes trauma to a plant in comparison to larger profile devices including syringes, plug, pegs or the like having dimensions of around 7 mm (7.14 mm in one example) a full 2 mm larger than the example tip. Accordingly, the potential for tree damage is reduced and the potential for fungal, bacterial, and insect ingress is minimized (e.g., reduced or eliminated). In one example, the tip as well as the other tip examples described herein are readily used with plants having stems, trunks, limbs or the like having diameters larger than 4.68 mm including, but not limited to, fruit trees, nut trees, berry shrubs, flowering plantsm as well as arbor and forest trees.

In certain embodiments, the injection tools selected allow for precision delivery (also referred to as “precision injection”) of a formulation into the plant. Precision delivery refers to delivering the formulation only or substantially only into a target location in the plant. For example, in some embodiments, the target location is the active vasculature of the tree. In some variations, the active vasculature of a tree is the xylem and/or the phloem. In other embodiments, precisely delivering the liquid formulation comprises inserting the injection tool such that the distribution reservoir is positioned in and no further than the active vasculature of the plant.

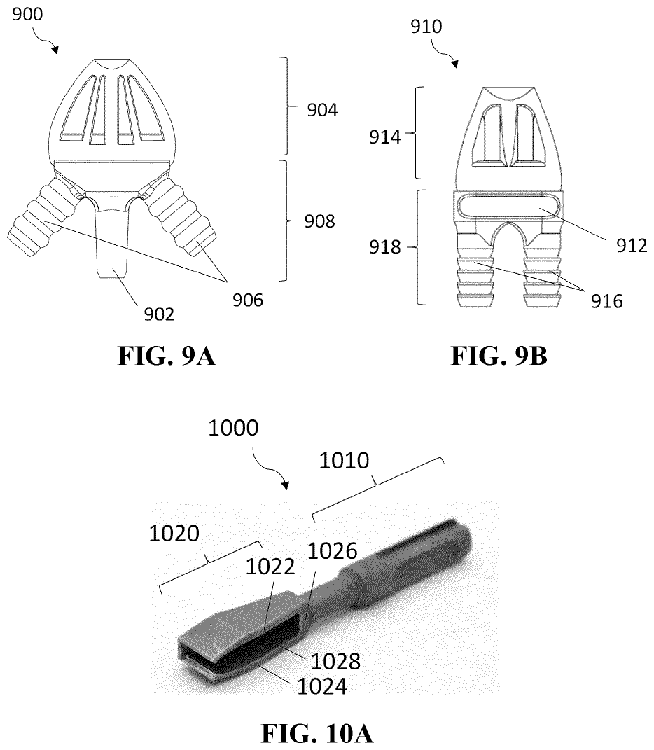

In some embodiments, the injection tools selected have one or more features designed to engage or couple with a tip adapter or a tip setter. For example, with reference to FIG. 9A, exemplary injection tool 900 with anchor 902 is configured to interface, engage, or couple with a tip setter or a tip adapter. Injection tool 900 has tool body 904 designed to be lodged into a plant part, ports 906 connectable to tubing, and tool base 908. With reference to FIG. 9B, exemplary injection tool 910 with groove 912 is configured to interface, engage, or couple with a tip setter or a tip adapter. Injection tool 910 has tool body 914 designed to be lodged into a plant part, ports 916 connectable to tubing, and tool base 918 that includes groove 912.

### Fluid Delivery System

In some embodiments, the injection tool compatible with the tip adapters and tip setters described herein is operatively connected to a fluid delivery system that contains the liquid formulation. In some embodiments, the fluid delivery system and the source of the liquid formulation are integrated into a formulation cartridge, such as a pressurized container. In some variations, the formulation cartridge is a pressurized canister. In operation, the liquid formulation flows from the fluid delivery system through the injection tool into the plant. See, e.g., WO 2020/021041.

In some embodiments, the injection systems or components thereof used in the methods described herein are as depicted in the figures. In some embodiments, the systems are configured to administer liquid formulation comprising one or more active ingredients (including, for example, nutrients) to a plant or a part thereof. In some embodiments, such systems are mounted onto a post portion of a plant, for example, to a trunk of the tree.

In some embodiments, the methods provided herein include installing an injection tool in the stem, trunk, root or limb of a plant, operatively connecting the injection tool to a fluid delivery system, and activating the fluid delivery system to initiate the flow of fluid from the fluid delivery system through the injection tool and into the plant. In some embodiments, two or more injection tools are installed into one or more of the stem, trunk, roots, limbs or the like of a plant to minimize trauma to the plant (e.g., by minimizing the size of a unitary hole in the plant or spacing the tools apart along the plant). In some such embodiments, the two or more injection tools are operatively connected to the same fluid delivery system. In some such embodiments the two or more injection tools are operatively connected to independent fluid delivery system.

In some variations, the fluid delivery system comprises a spring-loaded fluid delivery system. In some variations of the foregoing, the spring-loaded fluid delivery system is configured to operate at a pressure between 1.5-3 bar. In some variations, the fluid delivery system comprises a fluid delivery system comprising a pressurized container (e.g., a pressurized canister).

In some exemplary embodiments, the spring-loaded fluid delivery system may have a base holding one or multiple springs within one or multiple corresponding syringes. The design of the spring-loaded fluid delivery system may vary based on the pressure, volume, time or other appropriate parameters to deliver the liquid formulation. For example, in some variations, multiple springs (such as a dual spring) may be employed in the fluid delivery system to allow for injection of a higher volume of the liquid formulation. In some variations, a single spring with a larger syringe may be used, but may affect pressure range employed to inject the liquid formulation.

In some variations, the delivery unit is designed as a pneumatically or hydraulically operated dosing pump configured to administer a fluid formulation (e.g., a fluid including one or more of a liquid, gas, gel, vapor, aerosol, colloids, micro/nanoparticles, biological organisms, or the like). Alternatively, the delivery unit is designed as a pneumatic or hydraulic delivery pump configured to provide one or more pressures. In some examples, the pressures provided are proximate to but greater than ambient pressure to provide gradual low pressure delivery of the formulation to a plant. In another example, the delivery unit provides the liquid formulation in a passive manner, for instance by way of hydrostatic pressure or capillary action. The delivery device is, in one example, designed as a two-chamber assembly, wherein two chambers are arranged in a container, of which one chamber contains a pressure medium and the other contains an active ingredient formulation which can be expelled from the two-chamber assembly through a valve by the pressure medium. See, e.g., WO 2020/212612.

### Kits

In some aspects, provided herein are kits.

In some embodiments, a kit comprises a tip setter and an injection tool provided herein. In some variations, a kit comprises a tip setter, an injection tool, and a package insert containing instructions for use (e.g., for inserting the injection tool into a plant part using the tip setter).

In some embodiments, a kit comprises a tip setter and a tip adapter. In some variations, a kit comprises a tip setter, a tip adapter, and a package insert containing instruction for use (e.g., for positioning the tip adapter relative to the tip setter, and using the tip setter for inserting an injection tool into a plant part).

In some embodiments, a kit comprises an injection tool and a tip adapter. In some variations, a kit comprises an injection tool, a tip adapter, and a package insert containing instruction for use (e.g., for positioning the tip adapter relative to the tip setter).

In some embodiments, a kit comprises a tip setter, a tip adapter, and an injection tool. In some variations, a kit comprises a tip setter, a tip adapter, an injection tool, and a package insert containing instruction for use (e.g., for positioning the tip adapter relative to the tip setter, and using the tip setter for inserting the injection tool into a plant part).

In other variations of the foregoing, the kits may further comprise a fluid delivery system (e.g., optionally containing active ingredient or configured to receive active ingredient), and optionally a chassis configured to hold the fluid delivery system and connect with the tip setter).

### Liquid Formulations

Any suitable liquid formulations may be used in the injection systems compatible with the tip adapters and tip setters described herein. In some embodiments, the liquid formulation is water soluble. In some variations, the liquid formulation comprises nutrients. In some variations, the liquid formulation comprises micronutrients. In some variations, the liquid formulation is a semi-liquid formulation. In some variations, the liquid formulation is a gel formulation. In some variations, the liquid formulation is delivered as a semi-liquid or a gel formulation.

Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples of typical formulations include water-soluble liquids (SL), emulsifiable concentrates (EC), emulsions in water (EW), suspension concentrates (SC, SE, FS, OD), water-dispersible granules (WG) and fluids (which include one or more of a liquid, gas, gel, vapor, aerosol or the like). These and other possible types of formulation are described, for example, by Crop Life International and in Pesticide Specifications, Manual on development and use of FAO and WHO specifications for pesticides, FAO Plant Production and Protection Papers, prepared by the FAO/WHO Joint Meeting on Pesticide Specifications, 2004, ISBN: 9251048576; “Catalogue of pesticide formulation types and international coding system,” Technical Monograph No. 2, 6th Ed. May 2008, CropLife International.

In some embodiments, compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples for suitable auxiliaries are solvents, liquid carriers, surfactants, dispersants, emulsifiers, wetters, adjuvants, solubilizers, penetration enhancers, protective colloids, humectants, repellents, attractants, feeding stimulants, compatibilizers, bactericides, anti-freezing agents, antifoaming agents, colorants, stabilizers or nutrients, UV protectants, tackifiers, and/or binders. Specific examples for each of these auxiliaries are well known to the person of ordinary skill in the art, see, for example, US 2015/0296801 A1.

The compositions can optionally comprise 0.1-80% stabilizers and/or nutrients and 0.1-10% UV protectants. General examples of suitable ratios for multiple formulation types referenced above are given in Agrow Reports DS243, T&F Informa, London, 2005.

At certain application rates, the compositions and/or formulations according to the disclosure may also have a strengthening effect in plants. “Plant-strengthening” (resistance-inducing) substances are to be understood as meaning, in the present context, those substances or combinations of substances which are capable of stimulating the defence system of plants in such a way that, when subsequently inoculated with harmful microorganisms, the treated plants display a substantial degree of resistance to these microorganisms.

### Active Ingredients

In some embodiments, when applying active ingredients, the application can be continuous over a longer period or intervals. In some variations, the application could also be coupled with a disease monitoring system and be triggered “on demand.” In some variations, the formulations can comprise between 0.5% and 90% by weight of active compound, based on the weight of the formulation.

Numerous active ingredients can be used in the injection systems compatible with the tip adapters and tip setters described herein. The active ingredients specified herein by their “common name” are known and described, for example, in The Pesticide Manual (18^{th} edition, Ed. Dr. J A Turner (2018), which includes, among other agents, herbicides, fungicides, insecticides, acaricides, nematocides, plant growth regulators, repellants, synergists) or can be searched in the internet (e.g., alanwood.net/pesticides). Further, the active ingredient can be selected from the following groups of compounds and compositions:

1. Fungicides

1.1 Respiration inhibitors

1.1.1 Inhibitors of complex III at Qo site, for example, azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyrao-xystrobin, trifloxystrobin, pyribencarb, triclopyricarb/chlorodincarb, famoxadone, and/or fenamidone;

1.1.2 Inhibitors of complex III at Qi site: cyazofamid and/or amisulbrom;

1.1.3 Inhibitors of complex II: flutolanil, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam and/or thifluzamide;

1.1.4 Other respiration inhibitors (e.g., complex I, uncouplers): diflumetorim;

1.1.5 Nitrophenyl derivates: binapacryl, dinobuton, dinocap, fluazinam; ferimzone; organometal compounds: fentin-acetate, fentin chloride and/or fentin hydroxide; ametoctradin; and/or silthiofam;

1.2 Sterol biosynthesis inhibitors (SBI fungicides)

1.2.1. C14 demethylase inhibitors (DMI fungicides): triazoles: azaconazole, bitertanol, bromuconazole, cyproconazole, difenoconazole,diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and/or uniconazole;

1.2.2 Imidazoles: imazalil, pefurazoate, prochloraz, triflumizol; pyrimidines, pyridines and piperazines: fenarimol, nuarimol, pyrifenox, triforine; Delta14-reductase inhibitors: aldimorph, dodemorph, dodemorph-acetate, fenpropimorph, tridemorph, fenpropidin, piperalin, spiroxamine; Inhibitors of 3-keto reductase: fenhexamid;

1.3 Nucleic acid synthesis inhibitors:

1.3.1 Phenylamides or acyl amino acid fungicides: benalaxyl, benalaxyl-M, kiral-axyl, metalaxyl, ofurace, oxadixyl;others: hymexazole, octhilinone, oxolinic acid, bupirimate and/or, 5-fluorocytosine;

1.4 Inhibitors of cell division and cytoskeleton

1.4.1 Tubulin inhibitors: benzimidazoles, thiophanates: benomyl, carbendazim, fuberidazole, thiabendazole, thiophanate-methyl; triazolopyrimidines:

1.4.2 Cell division inhibitors: diethofencarb, ethaboxam, pencycuron, fluopicolide, zoxamide, metrafenone and/or, pyriofenone;

1.5 Inhibitors of amino acid and protein synthesis

1.5.1 Methionine synthesis inhibitors (anilino-pyrimidines): cyprodinil, mepanipyrim, pyrimethanil;protein synthesis inhibitors: blasticidin-S, kasugamycin, kasugamycin hydrochloride-hydrate, mildiomycin, streptomycin, oxytetracyclin, polyoxine, validamycin A;

1.6. Signal transduction inhibitors

1.6.1 MAP/histidine kinase inhibitors: fluoroimid, iprodione, procymidone, vinclozolin, fenpiclonil, fludioxonil;G protein inhibitors: quinoxyfen;

1.7 Lipid and membrane synthesis inhibitors

1.7.1 Phospholipid biosynthesis inhibitors: edifenphos, iprobenfos, pyrazophos, isoprothiolane; lipid peroxidation: dicloran, quintozene, tecnazene, tolclofos-methyl, biphenyl, chloroneb, etridiazole; phospholipid biosynthesis and cell wall deposition: dimethomorph, flumorph, mandipropamid, pyrimorph, benthiavalicarb, iprovalicarb, valifenalate;

1.7.2 Compounds affecting cell membrane permeability and fatty acids: propamocarb, propamocarb-hydrochloridfatty acid amide

1.8 Inhibitors with Multi Site Action

1.8.1 Inorganic active substances: Bordeaux mixture, copper acetate, copper hydroxide, copper oxychloride, basic copper sulfate, sulfur; thio- and dithiocarbamates: ferbam, mancozeb, maneb, metam, metiram, propineb, thiram, zineb, ziram; organochlorine compounds (e.g., phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, and others: guanidine, dodine, dodine free base, guazatine, guazatine-acetate, iminoctadine, iminoctadine-triacetate, iminoctadinetris(albesilate), dithianon;

1.9 Cell wall synthesis inhibitors

1.9.1 Inhibitors of glucan synthesis: validamycin, polyoxin B; melanin synthesis inhibitors: pyroquilon, tricyclazole, carpropamid, dicyclomet and/or fenoxanil;

1.10 Plant defence inducers

1.10.1 Acibenzolar-S-methyl, probenazole, isotianil, tiadinil, prohexadione-calcium; phosphonates: fosetyl, fosetyl-aluminum, phosphorous acid and its salts;

1.11 Unknown mode of action

1.11.1 Bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxine-copper, picarbutrazox, proquinazid, tebufloquin, tecloftalam and/or triazoxide;

1.12 Antifungal biological Control Agents: Ampelomyces quisqualis (e.g., AQ 10® from Intrachem Bio GmbH & Co. KG, Germany), Aspergillus flavus (e.g., AFLAGUARD® from Syngenta, CH), Aureobasidium pullulans (e.g., BOTECTOR® from bio-ferm GmbH, Germany), Bacillus pumilus (e.g., NRRL Accession No. B-30087 in SONATA® and BALLAD® Plus from AgraQuest Inc., USA), Bacillus subtilis (e.g., isolate NRRL-Nr. B-21661 in RHAPSODY®, SERENADE® MAX and SERENADE® ASO from AgraQuest Inc., USA), Bacillus subtilis var. amyloliquefaciens FZB24 (e.g., TAEGRO® from Novozyme Biologicals, Inc., USA), Candida oleophila I-82 (e.g., ASPIRE® from Ecogen Inc., USA), Candida saitoana (e.g., BIOCURE® (in mixture with lysozyme) and BIOCOAT® from Micro Flo Company, USA (BASF SE) and Arysta), Chitosan (e.g., ARMOUR-ZEN from BotriZen Ltd., NZ), Clonostachys rosea f catenulata, also named Gliocladium catenulatum (e.g., isolate J1446: PRESTOP® from Verdera, Finland), Coniothyrium minitans (e.g., CONTANS® from Prophyta, Germany), Cryphonectria parasitica (e.g., Endothia parasitica from CNICM, France), Cryptococcus albidus (e.g., YIELD PLUS® from Anchor Bio-Technologies, South Africa), Fusarium oxysporum (e.g., BIOFOX® from S.I.A.P.A., Italy, FUSACLEAN® from Natural Plant Protection, France), Metschnikowia fructicola (e.g., SHEMER® from Agrogreen, Israel), Microdochium dimerum (e.g., ANTIBOT® from Agrauxine, France), Phlebiopsis gigantea (e.g., ROTSOP® from Verdera, Finland), Pseudozyma flocculosa (e.g., SPORODEX® from Plant Products Co. Ltd., Canada), Pythium oligandrum DV74 (e.g., POLYVERSUM® from Remeslo SSRO, Biopreparaty, Czech Rep.), Reynoutria sachlinensis (e.g., REGALIA® from Marrone Bio-Innovations, USA), Talaromyces flavus V117b (e.g., PROTUS® from Prophyta, Germany), Trichoderma asperellum SKT-1 (e.g., ECO-HOPE® from Kumiai Chemical Industry Co., Ltd., Japan), T. atroviride LC52 (e.g., SENTINEL® from Agrimm Technologies Ltd, NZ), T. harzianum T-22 (e.g., PLANTSHIELD® der Firma BioWorks Inc., USA), T. harzianum TH 35 (e.g., ROOT PRO® from Mycontrol Ltd., Israel), T. harzianum T-39 (e.g., TRICHODEX® and TRICHODERMA 2000® from Mycontrol Ltd., Israel and Makhteshim Ltd., Israel), T. harzianum and T. viride (e.g., TRICHOPEL from Agrimm Technologies Ltd, NZ), T. harzianum ICC012 and T. viride ICC080 (e.g., REMEDIER® WP from Isagro Ricerca, Italy), T. polysporum and/or T. harzianum (e.g., BINAB® from BINAB Bio-Innovation AB, Sweden), T. stromaticum (e.g., TRICOVAB® from C.E.P.L.A.C., Brazil), T. virens GL-21 (e.g., SOILGARD® from Certis LLC, USA), T. viride (e.g., TRIECO® from Ecosense Labs. (India) Pvt. Ltd., Indien, BIO-CURE® F from T. Stanes & Co. Ltd., Indien), T. viride TV1 (e.g., T. viride TV1 from Agribiotec srl, Italy), Ulocladium oudemansii HRU3 (e.g., BOTRY-ZEN® from Botry-Zen Ltd, NZ), Beauveria bassiana PPRI 5339 (commercially available from Becker Underwood as product “BroadBand”), Metarhizium anisopliae FI-1045 (commercially available from Becker Underwood as product “BioCane”), Metarhizium anisopliae var. acridum FI-985 (commercially available from Becker Underwood as product “GreenGuard”), and/or Metarhizium anisopliae var. acridum IMI 330189 (commercially available from Becker Underwood as product “Green Muscle”).

In some embodiments, active ingredients can also include protein or secondary metabolites. The term “protein or secondary metabolites” refers to any compound, substance or by-product of a fermentation of a microorganism that has pesticidal activity. The definition comprises any compound, substance or by-product of a fermentation of a microorganism that has pestocodal, including, fungicidal or insecticidal, activity. Examples of such proteins or secondary metabolites are Harpin (isolated by Erwinia amylovora, product known as e.g., Harp-N-Tek™, Messenger®, Employ™, ProAct™); and/or terpene constituents and mixture of terpenes, i.e. a-terpinene, p-cymene and limonene (product known as e.g., Requiem® from Bayer CropScience LP, US).

In some embodiments, useful proteins may also include antibodies against fungal target proteins, or other proteins with antifungal activity such as defensins and/or proteinase inhibitor. Defensins may include, for example, NaD1, PhD1A, PhD2, Tomdef2, RsAFP2, RsAFP1, RsAFP3 and RsAFP4 from radish, DmAMP1 from dahlia, MsDefl, MtDef2, CtAMP1, PsD1, HsAFP1, VaD1, VrD2, ZmESR6, AhAMP1 and AhAMP4 from Aesculus hippocatanum, AfIAFP from alfalfa, NaD2, AX1, AX2, BSD1, EGAD1, HvAMP1, JI-2, PgD1, SD2, SoD2, WT1, p139 and p1230 from pea. Proteinase inhibitors may include proteinase inhibitor from the following classes: serine-, cysteine-, aspartic- and metallo-proteinase inhibitors and carboxypeptidases such as StPin1A (U.S. Pat. No. 7,462,695) or Bovine Trypsin Inhibitor I-P.

2. Insecticidal compound

2.1 Acetylcholine esterase inhibitors from the class of carbamates: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and/or, triazamate;

2.2 Acetylcholine esterase inhibitors from the class of organophosphates: acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl)salicylate, isoxathion, malathion, mecarbam, methamidophos, methidathion, mevinphos, monocrotophos, nalad, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and/or vamidothion;

2.3 GABA-gated chloride channel antagonists

2.4 Cyclodiene organochlorine compounds: endosulfan; orM-2.B fiproles (phenylpyrazoles): ethiprole, fipronil, flufiprole, pyrafluprole, or pyriprole;

2.5 Sodium channel modulators from the class of pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, betacyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, momfluorothrin, empenthrin, esfenvalerate, etofenprox, fenpropathrin, fenvalerate, flucythrinate, flumethrin, tau-fluvalinate, halfenprox, imiprothrin, meperfluthrin, metofluthrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin, DDT and/or, methoxychlor;

2.6 Nicotinic acteylcholine receptor agonists from the class of neonicotinoids: acteamiprid, chlothianidin, cycloxaprid, dinotefuran, flupyradifurone, imidacloprid, nitenpyram, sulfoxaflor, thiacloprid and/or thiamethoxam;

2.7 Allosteric nicotinic acteylcholine receptor activators from the class of spinosyns: spinosad, spinetoram;

2.8 Chloride channel activators from the class of mectins: abamectin, emamectin benzoate, ivermectin, lepimectin and/or milbemectin;

2.9 Juvenile hormone mimics: hydroprene, kinoprene, methoprene, fenoxycarb and/or pyriproxyfen;

2.10 Non-specific multi-site inhibitors: methyl bromide and other alkyl halides, chloropicrin, sulfuryl fluoride, borax and/or tartar emetic;

2.11 Selective homopteran feeding blockers: pymetrozine, flonicamid and/or pyrifluquinazon;

2.12 Mite growth inhibitors: clofentezine, hexythiazox, diflovidazin and/or etoxazole;

2.13 Inhibitors of mitochondrial ATP synthase: diafenthiuron, azocyclotin, cyhexatin, fenbutatin oxide, propargite and/or tetradifon;

2.14 Uncouplers of oxidative phosphorylation: chlorfenapyr, DNOC and/or sulfluramid; M-13 nicotinic acetylcholine receptor channel blockers: bensultap, cartap hydrochloride, thiocyclam and/or thiosultap sodium;

2.15 Inhibitors of the chitin biosynthesis type 0 (benzoylurea class): bistrifluron, chlorfluazuron, diflubenzuron, flucycloxuron, flufenoxuron, hexaflumuron, lufenuron, novaluron, noviflumuron, teflubenzuron and/or, triflumuron;

2.16 Inhibitors of the chitin biosynthesis type 1: buprofezin;

2.17 Moulting disruptors: cyromazine;

2.18 Ecdyson receptor agonists: methoxyfenozide, tebufenozide, halofenozide, fufenozide and/or chromafenozide;

2.19 Octopamin receptor agonists: amitraz;

2.20 Mitochondrial complex III electron transport inhibitors: hydramethylnon, acequinocyl, flometoquin, fluacrypyrim and/or pyriminostrobin;

2.21 Mitochondrial complex I electron transport inhibitors: fenazaquin, fenpyroximate, pyrimidifen, pyridaben, tebufenpyrad, tolfenpyrad, flufenerim and/or rotenone;

2.22 Voltage-dependent sodium channel blockers: indoxacarb and/or metaflumizone

2.23 Inhibitors of the lipid synthesis, inhibitors of acetyl CoA carboxylase: spirodiclofen, spiromesifen and/or spirotetramat;

2.24 Mitochondrial complex II electron transport inhibitors: cyenopyrafen, cyflumetofen and/or pyflubumide;

2.25 Ryanodine receptor-modulators from the class of diamides: flubendiamide, chloranthraniliprole (rynaxypyr) and/or cyanthraniliprole (cyazypyr),

2.26 Others: afidopyropen,

2.27 Insecticidal biological control agents: Bacillus firmus (e.g., Bacillus firmus CNCM 1-1582, e.g., WO09126473A1 and WO09124707 A2, commercially available as “Votivo”) and/or δ-endotoxins from Bacillus thuringiensis (Bt).

3. A plant growth regulator:

3.1 Antiauxins: clofibric acid and/or 2,3,5-tri-iodobenzoic acid;

3.2 Auxins: 4-CPA, 2,4-D, 2,4-DB, 2,4-DEP, dichlorprop, fenoprop, IAA (indole-3-acetic acid), IBA, naphthaleneacetamide, α-naphthaleneacetic acid, 1-naphthol, naphthoxyacetic acid, potassium naphthenate, sodium naphthenate and/or 2,4,5-T;

3.3 Cytokinins: 2iP, 6-benzylaminopurine (6-BA), 2,6-dimethylpyridine and/or kinetin, zeatin;

3.4 Defoliants: calcium cyanamide, dimethipin, endothal, merphos, metoxuron, pentachlorophenol, thidiazuron, tribufos and/or tributyl phosphorotrithioate;

3.5 Ethylene modulators: aviglycine, 1-methylcyclopropene (1-MCP), prohexadione (prohexadione calcium) and/or trinexapac (trinexapac-ethyl);

3.6 Ethylene releasers: ACC, etacelasil, ethephon, glyoxime;Gibberellins: gibberelline, gibberellic acid;

3.7 Growth inhibitors: abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham and/or 2,3,5-tri-iodobenzoic acid;

3.8 Morphactins: chlorfluren, chlorflurenol, dichlorflurenol and/or flurenol;

3.9 Growth retardants: chlormequat (chlormequat chloride), daminozide, flurprimidol, mefluidide, paclobutrazol, tetcyclacis, uniconazole and/or metconazole;

3.10 Growth stimulators: brassinolide, forchlorfenuron and/or, hymexazol;

3.11 Unclassified plant growth regulators/classification unknown: amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, inabenfide, karetazan, lead arsenate, methasulfocarb, pydanon, sintofen and/or, triapenthenol.

In one embodiment, the fungicidal compound is selected from the group consisting of Dimoxystrobin, Pyraclostrobin, Azoxystrobin, Trifloxystrobin, Picoxystrobin, Cyazofamid, Boscalid, Fluoxapyroxad, Fluopyram, Bixafen, Isopyrazam, Benzovindiflupyr, Penthiopyrad, Ametoctradin, Difenoconazole, Metconazole, Prothioconazole, Tebuconazole, Propiconazole, Cyproconazole, Penconazole, Myclobutanil, Tetraconazole, Hexaconazole, Metrafenone, Zoxamid, Pyrimethanil, Cyprodinil, Metalaxyl, Fludioxonil, Dimethomorph, Mandipropamid, Tricyclazole, Copper, Metiram, Chlorothalonil, Dithianon, Fluazinam, Folpet, Fosetyl-Al, Captan, Cymoxanil, Mancozeb, Kresoxim-methyl, Oryzastrobin, Epoxiconazole, Fluquinconazole, Triticonazole, Fenpropimorph and Iprodione.

In one embodiment, the plant growth regulator is selected from the group consisting of 6-benzylaminopurine (=N-6-benzyladenine), chlormequat (chlormequat chloride), choline chloride, cyclanilide, dikegulac, diflufenzopyr, dimethipin, ethephon, flumetralin, fluthiacet, forchlorfenuron, gibberellic acid, inabenfide, maleic hydrazide, mepiquat (mepiquat chloride), 1-methylcyclopropene (1-MCP), paclobutrazol, prohexadione (prohexadione calcium), prohydrojasmon, thidiazuron, triapenthenol, Tributyl phosphorotrithioate, trinexapac-ethyl and uniconazole.

In another embodiment, the active ingredient is a biological control agent such as a bio-pesticide. In some embodiments, compared to conventional synthetic chemical pesticides, bio-pesticides are non-toxic, safe to use, and can have high specificity. In some variations, these can be used as a preventative (or curative) tool to manage diseases, nematodes and insects and other pests. In some embodiments, bio-pesticides allow for the reduction in the use of traditional chemical-based pesticides without affecting yields. The use of biological pesticides is compatible with the use for food and feed production and many of the biological agents are approved for consumption. This allows an all year use in food production systems like wine, banana, cocoa, coffee, and fruit plantations etc. where pest control is a major and increasing challenge. In one embodiment, the tools, systems and methods of the disclosure are employed in organic farming.

In one embodiment, the active ingredients are those which provide a systemic effect.

### Penetrants

In some embodiments, penetrants which facilitate and/or enhance the uptake and distribution of the active ingredient in the target plant can be used in the injection systems or injection tools compatible with the tip setters and tip adapters described herein. Suitable penetrants in the present context include all those substances which are typically used in order to enhance the penetration of active agrochemical compounds into plants. Examples include alcohol alkoxylates, such as coconut fatty ethoxylate, isotridecyl ethoxylate, fatty acid esters, such as rapeseed or soybean oil methyl esters, fatty amine alkoxylates, such as tallowamine ethoxylate, or ammonium and/or phosphonium salts, such as ammonium sulphate or diammonium hydrogen phosphate.

### Uses of the Injection Systems

The injection tools and injection systems compatible with the tip setters and tip adapters described herein can be used with any number of known injection methods and protocols such as, for example, those disclosed in PCT applications WO 2012/114197 or WO 2013/149993. The appropriate method and protocol will depend upon various factors including the nozzle tip, the tree species, the target (insect, nematode, disease, abiotic stress, etc.), the injection fluid components and/or viscosity, the dose volume required and the injection pressure.

In some embodiments, the method comprises delivering a formulation comprising one or more nutrients into a plant. In some embodiments, the method comprises precision delivery of a formulation into the plant. In some variations, precisely delivering the liquid formulation comprises inserting the injection tool such that the distribution reservoir is positioned in and no further than the active vasculature of the plant.

In some variations, the liquid formulation is delivered into and no further than the active vasculature of the plant when the injection tool is inserted into the post portion of the plant. In some variations, the liquid formulation is delivered into and no further than the active vasculature of the plant when the injection tool is inserted into the stem or trunk of the plant. In some variation, the liquid formulation is delivered into and no further than the xylem, or the phloem or both of the plant when the injection tool is inserted into the post portion of the plant. In one variation, the liquid formulation is delivered into and no further than the xylem, or the phloem or both of the plant when the injection tool is inserted into the stem or trunk of the plant.

In some embodiments, the methods deliver at least 50%, at least 60%, at least 70%, at least 80%, at least 90%, at least 95%, at least 96%, at least 97%, at least 98% or at least 99% of the liquid formulation into to the active vasculature of the plant. In some variation, the methods deliver at least 50%, at least 60%, at least 70%, at least 80%, at least 90%, at least 95%, at least 96%, at least 97%, at least 98% or at least 99% of the liquid formulation into the xylem and/or phloem of the plant.

In some embodiments, the method comprises injecting liquid formulation into the vasculature through one or more sites on post portion of the plant. In some embodiments, the method comprises injecting liquid formulation into the vasculature through one or more sites on the trunk of the tree. In embodiments where the formulation is injected through multiple injection sites, a plurality of the injection systems described herein may be used. In some embodiments where the formulation is injected through multiple injection sites, the system comprises multiple injection tools operatively connected to a single fluid delivery system.

The injection tools, injection systems and methods described herein generally provide one or more commercial advantages over the tools, systems and methods currently known in the art. Advantages include one or more of a faster return to the production yields pre-infection, fast response (e.g., curing), lower volumes of formulation needed, less loss of formulation to the environment, less damage to the tree, response in old trees including trees older than 100 years, response in trees with significant disease symptoms (e.g., with 50% or less remaining canopy foliage and faster administration to the trees).

The injection system according to the disclosure is suitable for being applied to various different plants. Thereby, the shape and dimensions of the injection tools involved advantageously are adapted to the intended application. More specifically, the injection tool can be designed for being applied to comparably large plants and specifically to trees, bushes or other woody plants. In other variations, the injection tool can be designed for being applied to comparably small or smaller plants. For example, in some variations, injection tools suitable for woody plants may have a total length of more than 50 mm or in a range of between 60 mm and 200 mm. The respective penetrating distribution bodies (e.g., shaft or wedge body profiles) include lengths of 35 mm or more and in some examples are in a range of between approximately 35 mm and 160 mm, and/or a width of 30 mm or more or are in a range of between approximately 35 mm and 150 mm. In contrast, in other variations, injection tools intended for comparably small plants optionally have a total length of between approximately 3 mm and 20 mm, between approximately 6 mm and 16 mm, or less than 10 mm.

In a further other aspect, described herein is a process of modulating the phenotype of a plant or a multitude of plants, said process including the steps of (i) installing a plant injection system according to the disclosure provided herein in the plant or multitude of plants, and (ii) applying a liquid formulation of an active ingredient to modulate the phenotype of the plant.

In some embodiments, the active ingredient is selected from the group consisting of (i) pesticides and (ii) growth regulators. In some embodiments, the active ingredient is a biological compound or composition approved for food and feed application.

Validating operation of the plant injection systems

In some embodiments, the methods of using the plant injection systems compatible with the tip setters and tip adapters described herein involve validating operation of the plant injection systems and delivering AIs into the interior of a plant. In some such embodiments, the methods include: installing a multiport injection tool into the trunk of a plant using a tip setter or a tip adapter described herein; delivering AIs to a first port of the multiport injection tip with the fluid receiving system in the closed position to prime the injection tip; thereafter setting the fluid receiving system to the open position and confirming fluid flow into the fluid receiving system from the first port to and through the second port; and thereafter setting the fluid receiving system to the closed position to maintain system pressure and facilitate delivery of fluid through the channel system to the distribution ports and interior of the plant. In further or alternative embodiments, the methods involve one or more of initializing the injection tip (including bleeding of intervening fluids, such as air), delivery of multiple AI formulations together, extraction of fluids for testing or flushing of the tool, and refilling of formulation reservoirs in communication with the tool.

In some embodiments, a multiport injection tool compatible with the tip setters and tip adapters described herein can be used in cooperation with a fluid receiving system as the basis for a method to confirm fluid flow from a fluid delivery system through the multiport injection tool. In some embodiments, with a multiport injection tool installed in a plant, the method comprises priming the multiport injection tool by activating a fluid delivery system with a fluid receiving system in the closed position (for example, by setting a shut-off valve on a hose connected to an access port to the closed position). Thereafter, the fluid receiving system is set to the open position (for example by opening the shut-off valve) allowing fluid to flow through the fluid receiving system. Flow of fluid through the fluid receiving system is an indicator that the multiport injection tool is functional at least so far as having an open pathway for fluid to flow from the fluid delivery system through the multiport injection tool to the fluid receiving device. After fluid flow is confirmed, the fluid receiving system is returned to the closed position and the plant injection system operates similarly to systems having an injection tool with only a single (entry) access port. The initializing sequence involving priming the multiport injection tool (activating the fluid delivery system with the fluid receiving device in a closed position) followed by evacuating fluid through the fluid receiving system (setting the fluid receiving system to an open position) may also result in flushing at least a portion of intervening fluid, such as air, which may be present in the system, from the plant injection system and in particular from the multiport injection tool.

### Suitable Plants

In some embodiments, the injection tool compatible with the tip setters or tip adapters described herein is inserted into the trunk/stem of the plant. In some variations, the trunk/stem (i) comprise a vascular system connected to the plant and/or (ii) has a diameter of at least 1 cm, such as at least 2 cm or 3 cm, or at least 4 cm or 5 cm. The trunk/stem may, for example, include trunks and branches of tree, large petioles, but also “false stems” or pseudostems of plants like bananas, which consist of tightly packed sheaths. Trunks/stems can be woody or non-woody.

Plants suitable for use with the tip setters and/or tip adapters described herein, including as well the injection tools and systems configured for use with the tip setters and/or tip adapters, can be selected from Tree Crops (e.g., Walnuts, Almonds, Pecans, Hazelnuts, Pistachios, etc.), citrus trees (Citrus spp. e.g., orange, lemon, grapefruit, mandarins etc.), Fruit Crops (such as pomes, stone fruits or soft fruits, for example apples, pears, plums, peaches, cherries etc.), Vine Crops (e.g., Grapes, Blueberries, Blackberries, etc.), coffee (Coffea spp.), coconut (Cocos iiucifera), pineapple (Ananas comosus), cocoa (Theobroma cacao), tea (Camellia sinensis), banana (Musa spp.), lauraceous plants (such as avocados (Persea americana), cinnamon or camphor), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), natural rubber tree, date tree, oil palm tree, ornamentals, forestry (e.g., pine, spruce, eucalyptus, poplar, conifers etc.) and/or box trees.

Conifers that may be employed in practicing the embodiments are selected from pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and/or Alaska yellow-cedar (Chamaeeyparis nootkatensis).

Palm trees that may be treated are selected from Archontophoenix alexandrae (king Alexander palm), Arenga spp. (Dwarf sugar palm), Borassus flabellifer (Lontar palm), Brahea armata (blue hesper palm), Brahea edulis (Guadalupe palm), Butia capitate (pindo palm), Chamaerops humilis (European fan palm), Carpentaria spp (Carpenteria palm), Chamaedorea elegans (parlor palm), C. erupens (bamboo palm), C. seifrizii (reed palm), Chrysalidocarpus lutescens (areca palm), Coccothrinax argentata (silver palm), C. crinite (old man palm), Cocos nucifera (coconut palm), Elaeis guineensis (African oil palm), Howea forsterana (kentia palm), Livistona rotundifolia (round leaf fan palm), Neodypsis decaryi (triangle palm); Normanbya normanbi (Queensland black); Pinanga insignis; Phoenix canariensis (Canary Island date); Ptychosperma macarthuri (Macarthur palm); Rhopalostylis spp (shaving brush p.); Roystonea elata (Florida royal palm), R. regia Cuban (royal palm), Sabal spp (Cabbage/palmetto), Syagrus romanzoffiana (queen palm), Trachycarpus fortune (windmill palm), Trythrinax acanthocoma (spiny fiber palm), Washingtonia filifera (petticoat palm) and/or W. robusta (Washington/Mexican fan palm). One embodiment includes the prevention or cure of bud rot of palm trees caused, for example, by Phytophthora palmivora, Thielaviopsis paradoxa and/or bacteria. Unlike most trees, which have many points where new growth emerges, palms rely on their single terminal bud. If the terminal bud or heart becomes diseased and dies, the tree will not be able to put out any new leaf growth and will die. That is why preventative care is needed to maintain a healthy palm tree.

### Advantages

In some embodiments, the injection tools and injection systems having the injection tools compatible with the tip setters and tip adapters described herein, and methods described herein facilitate the continuous application of liquid formulations including active ingredients to a large variety of plants, including, but not limited to, perennial plants with any kind of trunk or stem size. In some embodiments, the systems, components and methods of this disclosure enable administering active ingredients to plants at a reduced dosage rate as compared to foliar application. Reduced dosage rate is attractive because it may reduce the negative environmental impact of foliar application in which a high amount of the employed chemicals is-not reaching the target plant or pest but is release into the environmental where it may effect beneficial organism (e.g., bees) and or causes environmental pollution (e.g., ground water). And lower dosage rates may enable replacing chemical pesticides with biological control agents which are approved for human consumption but have high costs of goods which make a foliar use by spray applications in plantations of trees and other plants like banana, coffee, or cocoa punitively expensive.

In other embodiments, the injection systems and injection tools compatible with the tip adapters and tip setters described herein can be used to modulate phenotypes of plants, for instance to treat, prevent, protect and immunize, which means induce local and systemic resistance to plants from pathogenic attacks and pest attacks. The injection tools described herein distribute liquid formulations directly to the interior of the plant without spraying and the commensurate loss of errantly applied sprayed formulations. The subject matter described herein places the formulations in direct contact with plant tissues and in some embodiments, the formulations are selectively administered at appropriate times to minimize (e.g., eliminate or minimize) the accumulation of chemical residues in fruits or crops as mandated.

In some embodiments, this disclosure provides methods for enhancing or maintaining plant health using the injection systems and injection tools compatible with or can be installed with the tip adapters and tip setters described herein. In some embodiments, this disclosure provides methods for treating diseased plants and/or methods for controlling bacteria, fungi, viruses and/or other pathogens which cause disease in plants. In further such embodiments, this disclosure provides methods for treating plants whose xylem has been invaded by disease-causing bacteria, fungi, viruses, and/or other pathogens, for controlling the bacteria, fungi, virus and/or other pathogens causing the disease, and for preventing diseases by preventing sufficient colonization of the plant by the disease causing pathogens such as bacteria, fungi, and viruses.

Embodiments of the tools, systems and methods of the disclosure used with the tip adapters and tip setters described herein may enable a systemic or directed application of active ingredients into the vascular system of a plant, such as into the stem of a plant. These embodiments can be applied to large variety of plants, included but not limited to those listed below, and may be applicable to any and all other pathogenic diseases and/or complexes that are encountered in agriculture for example in horticulture.

In some embodiments, the present disclosure relates to enhancing plant health using the tools, systems, and methods with the tip adapters and tip setters described herein. Healthier plants are desirable since they result among others in better yields and/or a better quality of the plants or crops, specifically better quality of the harvested plant parts. Healthier plants also better resist to biotic and/or abiotic stress. A high resistance against biotic stresses in turn allows the person skilled in the art to reduce the quantity of pesticides applied and consequently to slow down the development of resistances against the respective pesticides.

Increased yield can be characterized, among others, by the following improved properties of the plant: increased plant weight; and/or increased plant height; and/or increased biomass such as higher overall fresh weight (FW); and/or increased number of flowers per plant; and/or higher grain and/or fruit yield; and/or more tillers or side shoots (branches); and/or larger leaves; and/or increased shoot growth; and/or increased protein content; and/or increased oil content; and/or increased starch content; and/or increased pigment content; and/or increased chlorophyll content (chlorophyll content has a positive correlation with the plant's photosynthesis rate and accordingly, the higher the chlorophyll content the higher the yield of a plant), increased quality of a plant. According to the present disclosure, the yield is increased by at least 4%. In general, the yield increase may even be higher, for example 5 to 10%, for example 10 to 20%, or even 20 to 30%

Another indicator for the condition of the plant is the plant vigor. The plant vigor becomes manifest in several aspects such as the general visual appearance. Another indicator for the condition of the plant is the “quality” of a plant and/or its products and/or the plant's tolerance or resistance to biotic and/or abiotic stress factors. Biotic and abiotic stress, especially over longer terms, can have harmful effects on plants.

In some embodiments, the tip setters and/or tip adapters provided herein, used in combination with suitable injection tools and systems, can be used as part of a method to reduce damage of plants and/or plant parts or losses in harvested fruits or plant produce caused by phytopathogenic fungi by controlling such phytopathogenic fungi, comprising applying the tip setters and/or tip adapters in combination with the injections tools, systems, agents/formulations or methods of the disclosure to the plant. Advantageously, the disclosure is for controlling, preventing, or curing the following fungal plant diseases selected from the group: Botrytis cinerea (teleomorph: Botryotinia fuckeliana: grey mold) on fruits and berries (e.g., strawberries), rape, vines, forestry plants; Ceratocystis (syn. Ophiostoma) spp. (rot or wilt) on broad-leaved trees and evergreens, e.g., C. ulmi (Dutch elm disease) on elms; Cercospora spp. (Cercospora leaf spots) on coffee,; Colletotrichum (teleomorph: Glomerella) spp. (anthracnose) on soft fruits; Cycloconium spp., e.g., C. oleaginum on olive trees; Cylindrocarpon spp. (e.g., fruit tree canker or young vine decline, teleomorph: Nectria or Neonectria spp.) on fruit trees, vines (e.g., C. liriodendri, teleomorph: Neonectria liriodendri: Black Foot Disease) and ornamentals; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtuse; Elsinoe spp. on pome fruits (E. pyn), soft fruits (E. veneta: anthracnose) and vines (E. ampelina: anthracnose); Eutypa lata (Eutypa canker or dieback, anamorph: Cytosporina lata, syn. Libertella blepharis) on fruit trees, vines and ornamental woods; Fusarium (teleomorph: Gibberella) spp. (wilt, root or stem rot) on various plants; Glomerella cingulata on vines, pome fruits and other plants; Guignardia bidwellii (black rot) on vines; Gymnosporangium spp. on rosaceous plants and junipers, e.g., G. sabinae (rust) on pears; Hemileia spp., e.g., H. vastatrix (coffee leaf rust) on coffee; Isariopsis clavispora (syn. Cladosporium vitis) on vines; Monilinia spp., e.g., M. taxa, M. fructicola and M. fructigena (bloom and twig blight, brown rot) on stone fruits and other rosaceous plants; Mycosphaerella spp. on bananas, soft fruits, such as, e.g., M. fijiensis (black Sigatoka disease) on bananas; Phialophora spp. e.g., on vines (e.g., P. tracheiphila and P. tetraspora); Phomopsis spp. on vines (e.g., P. viticola: can and leaf spot); Phytophthora spp. (wilt, root, leaf, fruit and stem root) on various plants, such as broad-leaved trees (e.g., P. ramorum: sudden oak death); Plasmopara spp., e.g., P. viticola (grapevine downy mildew) on vines; Podosphaera spp. (powdery mildew) on rosaceous plants, hop, pome and soft fruits, e.g., P. leucotricha on apples; Pseudopezicula tracheiphila (red fire disease or rotbrenner', anamorph: Phialophora) on vines; Ramularia spp., e.g., R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g., R. solani (root and stem rot) on soybeans, R. solani (sheath blight) on rice or R. cerealis (Rhizoctonia spring blight) on wheat or barley; Rhizopus stolonifer (black mold, soft rot) on vines; Uncinula (syn. Erysiphe) necator (powdery mildew, anamorph: Oidium tuckeri) on vines; Taphrina spp., e.g., T. deformans (leaf curl disease) on peaches and T. pruni (plum pocket) on plums; Thielaviopsis spp. (black root rot) on pome fruits; Venturia spp. (scab) on apples (e.g., V. inaequalis) and pears; and/or Verticillium spp. (wilt) on various plants, such as fruits and ornamentals, vines, soft fruits.

The disclosed subject matter is employed for controlling, preventing, or curing the diseases in plants selected from:

Diseases of apple: blossom blight (Monilinia mali), powdery mildew (Podosphaera leucotricha), Alternaria leaf spot/Alternaria blotch (Alteraaria alternata apple pathotype), scab (Venturia inaequalis), bitter rot (Colletotrichum acutatum), anthrax (Colletotrieiium acutatum), decomposed disease (Valsa ceratosperma), and/or crown rot (Phytophtora cactorum);

Diseases of pear: scab (Venturia nashicola, V. pirina), black spot/purple blotch (Alternaria alternate Japanese pear pathotype). rust/frogeye (Gymnosporangium haraeanum), and/or phytophthora fruit rot (Phytophtora cactorum);

Diseases of peach: brown rot (Monilinia fructicola), black spot disease/scab (Cladosporium carpophilum), and/or phomopsis rot (Phomopsis sp.);

Diseases of grape: anthracnose (Elsinoe ampelina), powdery mildew (Uncinula necator), ripe rot (Glomerella cingulata), black rot (Guignardia bidwelli i), downy mildew (Plasmopara viticola), rust (Phakopsora ampelopsidis), and/or gray mold (Botrytis cinerea);

Diseases of Japanese persimmon: anthracnose (Gloeosporium kaki) and/or leaf spot (Cercospora kaki, Mycosphaerella nawae);

Diseases of cruciferous vegetables: Alternaria leaf spot (Alternaria japonica), white spot (Cercosporella brassicae), and/or downy mildew (Peronospora parasitica); Diseases of rapeseed: sclerotinia rot (Sclerotinia sclerotiorum) and/or gray leaf spot (Alternaria brassicae);

Diseases of rose: black spot (Diplocarpon rosae) and/or powdery mildew (Sphaerotheca pannosa);

Disease of banana: sigatoka (Mycosphaerella fijiensis, Mycosphaerella musicola, Pseudocercospora musae); and/or Colletotrichum musae, Armillaria mellea, Armillaria tabescens, Pseudomonas solanacearum, Phyllachora musicola, Mycosphaerella fijiensis, Rosellinia bunodes, Pseudomas spp., Pestalotiopsis leprogena, Cercospora hayi, Pseudomonas solanacearum, Ceratocystis paradoxa, Verticillium theobromae, Trachysphaera fructigena, Cladosporium musae, Junghuhnia vincta, Cordana johnstonii, Cordana musae, Fusarium pallidoroseum, Colletotrichum musae, Verticillium theobromae, Fusarium spp Acremonium spp., Cylindrocladium spp., Deightoniella torulosa, Nattrassia mangiferae, Dreschslera gigantean, Guignardia musae, Botryosphaeria ribis, Fusarium solani, Nectria haematococca, Fusarium oxysporum, Rhizoctonia spp., Colletotrichum musae, Uredo musae, Uromyces musae, Acrodontium simplex, Curvularia eragrostidis, Drechslera musae-sapientum, Leptosphaeria musarum, Pestalotiopsis disseminate, Ceratocystis paradoxa, Haplobasidion musae, Marasmiellus inoderma, Pseudomonas solanacearum, Radopholus similis, Lasiodiplodia theobromae, Fusarium pallidoroseum, Verticillium theobromae, Pestalotiopsis palmarum, Phaeoseptoria musae, Pyricularia grisea, Fusarium moniliforme, Gibberella fujikuroi, Erwinia carotovora, Erwinia chrysanthemi, Cylindrocarpon musae, Meloidogyne arenaria, Meloidogyne incognita, Meloidogyne javanica, Pratylenchus coffeae, Pratylenchus goodeyi, Pratylenchus brachyurus, Pratylenchus reniformia, Sclerotinia sclerotiorum, Nectria foliicola, Mycosphaerella musicola, Pseudocercosporamusae, Limacinula tenuis, Mycosphaerella musae, Helicotylenchus multicinctus, Helicotylenchus dihystera, Nigrospora sphaerica, Trachysphaera frutigena, Ramichloridium musae, Verticillium theobromae;
Disease of citrus fruits: black spot disease (Diaporthe citri), scab (Elsinoe fawcetti), and/or fruit rot (Penicillium digitatum, P. italicum);
Disease of tea: net rice disease (Exobasidium reticulatum), disease victory (Elsinoe leucospila), ring leaf spot (Pestalotiopsis sp.), anthracnose (Colletotrichum theaesinensis;
Disease of plam trees: Bud Rot, Crown Rot, Red Ring, Pudricion de Cogollo, Lethal Yellowing;
Diseases of box tree: boxwood blight fungus (Cylindrocladium buxicola also called Calonectria pseudonaviculata), Volutella buxi, Fusarium buxicola.

The methods of the disclosure can be used to reduce damage caused by a wide range of insect pests. Target insects can be selected from the order of Lepidoptera, Coleoptera, Diptera, Thysanoptera, Hymenoptera, Orthoptera, Acarina, Siphonaptera, Thysanura, Chilopoda, Dermaptera, Phthiraptera, Hemipteras, Homoptera, Isoptera and/or Aptero. Examples of such pests include, but are not limited to, Arthropods, including, for example, Lepidoptera (for example, Plutellidae, Noctuidae, Pyralidae, Tortricidae, Lyonetiidae, Carposinidae, Gelechiidae, Crambidae, Arctiidae, and/or Lymantriidae), Hemiptera (for example, Cicadellidae, Delphacidae, Psyllidae, Aphididae, Aleyrodidas, Orthezidae, Miridae, Tingidae, Pentatomidae, and/or Lygaiedae), Coleoptera (for example, Scarabaeidae, Elateridae, Coccinellidae, Cerambycidae, Chrysomelidae, and/or Curculionidae), Diptera (for example, Muscidae, Calliphoridae, Sarcophagidae, Anthomyiidae, Tephritidae, Opomyzoidea, and/or Carnoidea), Orthoptera (for example, Acrididae, Catantopidae, and Pyrgomorphidae), Thysanoptera (for example, Thripidae, Aeolothripidae, and Merothripidae), Tylenchida (for example, Aphelenchoididae and/or Neotylechidae), Collembola (for example, Onychiurus and lsotomidae), Acarina (for example, Tetranychidae, Dermanyssidae, Acaridae, and/or Sarcoptidae), Stylommatophora (for example, Philomycidae and/or Bradybaenidae), Ascaridida (for example, Ascaridida and/or Anisakidae), Opisthorchiida, Strigeidida, Blattodea (for example, Blaberidae, Cryptocercidae, and/or Panesthiidae), Thysanura (for example, Lepismatidae, Lepidotrichidae, and/or Nicoletiidae) and/or box tree moth / box tree caterpillar (Cydalima perspectalis).

The disclosure is also useful against bacterial pathogens that attack, consume (in whole or in part), or impede the growth and/or development of plants and/or act as transmission vectors to the plant and/or other plants caused by such bacterial pathogens. The bacterial pathogens can include Agrobacterium, Agrobacterium tumefaciens, Erwinia, Erwinia amylovora, Xanthomonas, Xanthomonas campestris, Pseudomonas, Pseudomonas syringae, Ralstonia solanacearum, Corynebacterium, Streptomyces, Streptomyces scabies, Actinobacteria, Micoplasmas, Spiroplasmas and/or Fitoplasmas.

The disclosure is also useful for mitigating, controlling and/or eradicating viral pathogens that attack, consume (in whole or in part), or impede the growth and/or development of the plant and/or act as transmission vectors to the plant and/or other plants caused by such viral pathogens. Such viral pathogens can include Carlaviridae, Closteroviridae, viruses that attack citrus fruits, Cucumoviridae, Ilarviridae, dwarf virus attacking prunes, Luteoviridae, Nepoviridae, Potexviridae, Potyviridae, Tobamoviridae, Caulimoviridae, as well as other viruses that attack vegetation and crops.

Plant growth-regulating compounds can be used, for example, to inhibit the vegetative growth of the plants. Such inhibition of growth is of economic interest, for example, the inhibition of the growth of herbaceous and woody plants on roadsides and in the vicinity of pipelines or overhead cables, or quite generally in areas where vigorous plant growth is unwanted. Inhibition of the vegetative plant growth may also lead to enhanced yields because the nutrients and assimilates are of more benefit to flower and fruit formation than to the vegetative parts of the plants. Frequently, growth regulators can also be used to promote vegetative growth. This is of great benefit when harvesting the vegetative plant parts. However, promoting vegetative growth may also promote generative growth in that more assimilates are formed, resulting in more or larger fruits.

Use of growth regulators can control the branching of the plants. On the one hand, by breaking apical dominance, it is possible to promote the development of side shoots, which may be highly desirable particularly in the cultivation of ornamental plants, also in combination with an inhibition of growth. On the other hand, however, it is also possible to inhibit the growth of the side shoots. This effect is of particular interest, for example, in the cultivation of tobacco or in the cultivation of tomatoes. Under the influence of growth regulators, the amount of leaves on the plants can be controlled such that defoliation of the plants is achieved at a desired time. Such defoliation plays a major role in the mechanical harvesting of cotton, but is also of interest for facilitating harvesting in other crops, for example in viticulture.

Growth regulators can also be used to achieve faster or delayed ripening of the harvested material before or after harvest. This is particularly advantageous as it allows optimal adjustment to the requirements of the market. Moreover, growth regulators in some cases can improve fruit color. In addition, growth regulators can also be used to concentrate maturation within a certain period of time. This establishes the prerequisites for complete mechanical or manual harvesting in a single operation, for example in coffee.

By using growth regulators, it is additionally possible to influence the resting of seed or buds of the plants, such that plants, including pineapple or ornamental plants in nurseries, for example, germinate, sprout or flower at a time when they are normally not inclined to do so.

Further, growth regulators can induce resistance of the plants to frost, drought or high salinity of the soil. This allows the cultivation of plants in regions which are normally unsuitable.

The compositions and/or formulations according to the disclosure also exhibit a potent strengthening effect in plants. Accordingly, they can be used for mobilizing the defences of the plant against attack by undesirable microorganisms. Plant-strengthening (resistance-inducing) substances are to be understood as meaning, in the present context, those substances which are capable of stimulating the defence system of plants in such a way that the treated plants, when subsequently inoculated with undesirable microorganisms, develop a high degree of resistance to these microorganisms. The active compounds according to the disclosure are also suitable for increasing the yield of crops. In addition, they show reduced toxicity and are well tolerated by plants.

Further, in context with the present disclosure plant physiology effects comprise the following (all of which can be modulated by the compositions, methods and devices provided herein):

Abiotic stress tolerance, comprising temperature tolerance, drought tolerance and recovery after drought stress, water use efficiency (correlating to reduced water consumption), flood tolerance, ozone stress and UV tolerance, tolerance towards chemicals like heavy metals, salts, pesticides (safener) etc.

Biotic stress tolerance, comprising increased resistance fungal diseases, increased resistance against nematodes, viruses and bacteria.

Increased plant vigor, comprising plant health, plant quality, seed vigor, reduced stand failure, improved appearance, increased recovery, improved greening effect and improved photosynthetic efficiency.

In addition, the inventive treatment can reduce the mycotoxin content in the harvested material and the foods and feeds prepared therefrom.

In another embodiment of the disclosure the tools, system, compositions/formulations and methods are employed to provide to the plant nutritional elements like nitrogen, phosphorous and potassium, as well as mineral elements, including but not limited to, silicium, calcium, magnesium and manganese.

1. A tip setter for installing an injection tool to a plant part, wherein the tip setter comprises a rod,
wherein the rod comprises: a front end and a rear end; and
wherein the front end of the rod is configured to directly or indirectly connect to the injection tool.

2. The tip setter of clam 1, wherein the front end of the rod is configured to directly receive the injection tool.

3. The tip setter of claim 1, wherein the front end of the rod is configured to indirectly receive the injection tool.

4. The tip setter of claim 3, wherein the front end of the rod is configured to receive a chassis housing the injection tool.

5. The tip setter of claim 3, wherein the front end of the rod is configured to receive a tip adapter coupled to the injection tool.

6. The tip setter of claim 1, further comprising a grip, wherein the rear end of the tip setter is connected to the grip.

7. The tip setter of claim 1, wherein the plant part has a diameter of more than or equal to 8 mm.

8. A tip setter for installing an injection tool to a plant part, wherein the tip setter comprises: an arm, a fixed jaw, a middle grip, and a sliding unit,
wherein the arm comprises: a front end and a rear end;
wherein the fixed jaw is connected to the front end of the arm;
wherein the middle grip is connected to the rear end of the arm;
wherein the sliding unit comprises: a front end and a rear end;
wherein the sliding unit is configured to slide toward the front end of the arm;
wherein the front end of the sliding unit is configured to directly or indirectly connect to the injection tool; and
wherein the sliding unit and the fixed jaw are configured to receive the plant part between the injection tool and the fixed jaw.

9. The tip setter of clam 8, wherein the front end of the sliding unit is configured to directly receive the injection tool.

10. The tip setter of claim 8, wherein the front end of the sliding unit is configured to indirectly receive the injection tool.

11. The tip setter of claim 10, wherein the front end of the sliding unit is configured to receive a chassis housing the injection tool.

12. The tip setter of claim 10, wherein the front end of the sliding unit is configured to receive a tip adapter coupled to the injection tool.

13. The tip setter of claim 8, wherein the plant part has a diameter between 8 mm and 20 mm.

14. A tip setter for installing an injection tool to a plant part, wherein the tip setter comprises: an arm, a handle, a locking unit, a sliding unit, and a fixed jaw,
wherein the arm comprises: a first actuating end and a jaw end;
wherein the handle comprises: a second actuating end, a pivoting end, and a sliding end,
wherein the locking unit is connected to the pivoting end of the handle,
wherein the sliding unit is connected to the sliding end of the handle and configured to slide along the arm between the first actuating end and the jaw end, and to directly or indirectly receive the injection tool,
wherein the fixed jaw is connected to the jaw end of the arm, and
wherein the sliding unit and the fixed jaw are configured to receive the plant part between the injection tool and the fixed jaw.

15. The tip setter of claim 14, wherein, when the locking unit is in an adjustable mode, the locking unit can change position on the arm between the first actuating end and the jaw end, and when the locking unit is in a fixed mode, the locking unit is fixed at a position on the arm between the first actuating end and the jaw end.

16. The tip setter of claim 14, wherein, when the first actuating end and the second actuating end are moved toward each other while the locking unit is locked at a position on the arm, the sliding unit is configured to slide along the arm toward the jaw end of the arm, thereby moving the injection tool toward the plant part with sufficient force to penetrate the plant part.

17. The tip setter of claim 14, wherein the sliding unit is configured to directly receive the injection tool.

18. The tip setter of claim 14, wherein the sliding unit is configured to indirectly receive the injection tool.

19. The tip setter of claim 18, wherein the sliding unit is configured to receive a chassis housing the injection tool.

20. The tip setter of claim 18, wherein the sliding unit is configured to receive a tip adapter coupled to the injection tool.

21. The tip setter of claim 14, wherein the plant part has a diameter between 15 mm and 120 mm.

22. A tip adapter for installing an injection tool to a plant part, wherein the tip adapter comprises: a clamp and a connector,
wherein the clamp comprises a first side, a second side, and a base that form a U-shape having an interior surface and an exterior surface,
wherein the first side comprises a first lip extruding on the interior surface on the first side,
wherein the second side comprises a second lip extruding on the interior surface on the second side,
wherein the first lip and the second lip are configured to clamp on the injection tool, and
wherein the connector is connected to the exterior surface on the base.

23. A tip setter for installing an injection tool to a plant part, wherein the tip setter comprises:
an automatic hammer and a tip adapter,
wherein the automatic hammer is configured to receive the tip adapter, and
wherein the tip adapter comprises: a clamp and a connector,
wherein the clamp has a first side, a second side, and a base that form a U-shape having an interior surface and an exterior surface,
wherein the first side has a first lip extruding on the interior surface on the first side,
wherein the second side has a second lip extruding on the interior surface on the second side, and
the first lip and the second lip are configured to clamp on the injection tool,
wherein the connector is connected to the exterior surface on the base, and the connector is configured to insert into or couple with the automatic hammer.

24. The tip setter of claim 23, wherein the automatic hammer is configured to exert a stroke force without rotation on the tip adapter connected to the injection tool, so as to insert at least a part of the injection tool into the plant part.

25. The tip setter of claim 23, wherein the automatic hammer is a rotary drill or wrench with an impact mechanism that generates an impact or hammering motion.

26. The tip setter of claim 23, wherein the automatic hammer is a hammer drill, percussion drill, impact drill, air drill, impact driver, impact wrench, impactor, impact gun, air wrench, air gun, rattle gun, torque gun, or windy gun.

27. The tip setter of claim 23, wherein the automatic hammer is an electric device.

28. The tip setter of claim 23, wherein the automatic hammer is a pneumatic device.

29. The tip setter of claim 23, further comprising the injection tool interfaced with the tip adapter.

30. The tip setter of claim 29, wherein the injection tool is releasably interfaced with the tip adapter.

31. The tip setter of claim 29, wherein the injection tool comprises a tool body having a portion designed to be lodged into the plant part and at least one port connectable to tubing, wherein the portion designed to be lodged into the plant part is positioned externally to the tip adapter and the at least one port is positioned internally in the tip adapter.

32. The tip setter of claim 31, further comprising tubing, wherein at least a portion of the tubing is positioned within the tip adapter.

33. The tip setter of claim 29, wherein the injection tool comprises:
a tool body having a portion designed to be lodged into the plant part; and
a tool base connected to the tool body.

34. The tip setter of claim 33, wherein the tool base comprises at least one port configured to receive active ingredient; and
wherein the tool body comprises a channel system connected to at least one port, and the channel system is configured to distribute the active ingredient through the tool body into the plant part.

35. The tip setter of claim 33, wherein the tool base comprises at least one structural element configured to interface with the tip adapter.

36. The tip setter of claim 33, wherein one or both sides of the tool base comprise a groove designed to engage with the first lip and/or the second lip of the tip adapter, so as to secure the injection tool within the tip adapter.

37. A method of using the tip setter of claim 1, the method comprising:
(a) coupling the injection tool and the front end of the rod;
(b) placing the injection tool near the plant part;
(c) pushing the rod in the direction from the rear end of the rod to the front end of the rod to push the injection tool toward the plant part;
(d) inserting at least a part of the injection tool into the plant part; and
(e) releasing the injection tool from the tip setter.

38. A method of using the tip setter of claim 8, the method comprising:
(a) coupling the injection tool and the front end of the sliding unit;
(b) placing the plant part in between the injection tool and the fixed jaw;
(c) pushing the sliding unit in the direction from the rear end of the arm to the front end of the arm to push the injection tool toward the plant part;
(d) inserting at least a part of the injection tool into the plant part; and
(e) releasing the injection tool from the tip setter.

39. A method of using the tip setter of claim 14, the method comprising:
(a) coupling the injection tool and the sliding unit;
(b) placing the plant part in between the injection tool and the fixed jaw;
(c) moving the first actuating end and the second actuating end toward each other to push the sliding unit and the injection tool toward the plant part;
(d) inserting at least a part of the injection tool into the plant part; and
(e) releasing the injection tool from the tip setter.

40. A method of using the tip adapter of claim 22, the method comprising:
(a) inserting the injection tool between the first lip and the second lip;
(b) bringing the injection tool close to the plant part;
(c) pushing the tip adapter toward the plant part to insert at least a part of the injection tool into the plant part; and
(d) releasing the injection tool from the tip adapter.

41. The method of claim 40, wherein pushing the tip adapter toward the plant part is in the same direction as the longitudinal axis of the tip adapter.

42. The method of claim 40 [[or 41]], wherein pushing the tip adapter toward the plant part is performed manually.

43. The method of claim 40 [[or 41]], wherein pushing the tip adapter toward the plant part is performed using a hammer.

44. The method of claim 40 [[or 41]], wherein pushing the tip adapter toward the plant part is performed using a pneumatic device.

45. The method of claim 40 [[or 41]], wherein pushing the tip adapter toward the plant part is performed using a tip setter.

46. The method of claim 45, wherein the tip setter is the tip setter of any one of claims 1-36.

47. A method of using the tip setter of claim 23, the method comprising:
(a) coupling the injection tool and the tip adapter;
(b) placing the injection tool near the plant part;
(c) operating the automatic hammer to push the injection tool toward the plant part;
(d) inserting at least a part of the injection tool into the plant part; and
(e) releasing the injection tool from the tip setter.
